(19) United States
(12) Patent Application Publication
(10) Pub. No.: US 2024/0383258 A1
(43) Pub. Date: Nov. 21, 2024

(54) VALVE UNIT, LIQUID EJECTION HEAD, AND RECORDING APPARATUS

(71) Applicant: CANON KABUSHIKI KAISHA, Tokyo (JP)

(72) Inventors: TOSHIAKI KANEKO, Tokyo (JP); MANABU OHARA, Tokyo (JP)

(21) Appl. No.: 18/647,443

(22) Filed: Apr. 26, 2024

(30) Foreign Application Priority Data
May 17, 2023 (JP) 2023-081542

(51) Int. Cl. B41J 2/175; B41J 2/18

(52) U.S. Cl. CPC B41J 2/17596; B41J 2/18

(57) ABSTRACT

A valve unit includes a valve including (i) a body portion to be contained in a first chamber and (ii) a penetrating portion having an outer diameter smaller than an inner diameter of a through hole and provided in the body portion to penetrate through the through hole and extend to the inside of a second chamber. The valve is movable between an open position where a flow of a liquid through the through hole can be allowed and a restricted position where a flow of the liquid through the through hole can be restricted. When La is a width of a gap between an outer peripheral surface of the penetrating portion and an inner wall surface of the through hole and Lb is a width of a gap between an outer peripheral surface of the body portion and an inner wall surface of the first chamber, La≥1.2×Lb is satisfied.

### BACKGROUND OF THE INVENTION

### Field of the Invention

The present invention relates to a valve unit, a liquid ejection head, and a recording apparatus.

### Description of the Related Art

There is a serial-scan-type inkjet recording apparatus that records an image accompanied by movement of a carriage, on which a recording head is mounted, and has a configuration in which an ink tank is disposed not on the carriage, but in a main body of the recording apparatus, and such an apparatus is referred to as an apparatus of off-carriage type. This configuration allows the carriage to be reduced in size and weight, while allowing the ink tank to have a larger capacity. In the off-carriage-type recording apparatus, an ink is supplied from the ink tank to the recording head under an appropriate negative pressure added thereto.

In Japanese Patent Application Publication No. 2012-51200, a valve unit for performing such an ink supply is described. The valve unit has a valve containing chamber to which an ink is supplied from an ink tank and a pressure chamber that supplies the ink to a recording head and, in the valve containing chamber, a valve is provided to open/close a through hole provided in a partition wall separating the valve containing chamber and the pressure chamber from each other in a state where a portion of a valve body is inserted in the through hole. The pressure chamber has a support plate connected to a flexible film and configured to be movable, and is configured to have a cubic volume which is variable according to a pressure. The valve has a body portion located in the valve containing chamber and a penetrating portion extending from the body portion through the through hole to enter the inside of the pressure chamber, and the penetrating portion extending through the through hole can bring the through hole into an open state and into a closed state depending on a position of the body portion. The valve body receives a force from a spring in a direction of closing the through hole. When the ink in the pressure chamber is reduced by ink consumption by the recording head, the support plate moves in a direction of approaching the partition wall to reduce the cubic volume of the pressure chamber. When the support plate has moved over a given distance or longer, the support plate comes into contact with the penetrating portion of the valve to push the valve against the force of the spring and move the valve in a direction of opening the through hole. When the valve is moved to open the through hole, the ink flows from the ink tank into the pressure chamber via the valve containing chamber, and the support plate moves in a direction away from the partition wall to increase the cubic volume of the pressure chamber. When having moved over a given distance or longer, the support plate is separated from the penetrating portion of the valve, and the valve receives an operation of the spring to close the through hole. In the valve unit in which the valve is thus opened/closed by directly transmitting to the valve a displacement of the flexible film by a pressure plate, it is possible to stably supply the ink according to a state of ejection in the recording head during continuous printing, intermittent printing, a non-ejection period, or the like.

When a valve unit as described above is to be assembled, e.g., a wall portion of a valve containing chamber that faces a partition wall is formed of an opening portion and a lid portion capable of closing/opening the opening portion and, after a valve is inserted into the valve containing chamber from the opening portion, the opening portion is closed with the lid portion such that a spring is interposed between the valve and the lid portion. At this time, when the valve is inserted into the valve containing chamber, a center position of a penetrating portion may be displaced from a center position of a through hole. When the spring is pushed in, with the lid portion being in that state, it may be possible that a force of the spring does not act in a correct direction, and the valve collapses in the valve containing chamber or the spring is brought into a bent state. When the opening portion is closed, with the lid portion being in such a state, the valve does not appropriately operate. Even when the valve does not collapse or the spring is not bent, the penetrating portion and the through hole may be brought into contact with each other to possibly block an ink flow.

### SUMMARY OF THE INVENTION

The present invention enables a stable valve operation in a valve unit, in which a valve capable of opening/closing a through hole provided in a partition wall separating a valve containing chamber and a pressure chamber from each other in a state where a portion of a valve body is inserted in the through hole, is provided in the valve containing chamber.

The present invention is a valve unit comprising:
a first chamber to which a liquid is supplied from an external tank;
a second chamber communicating with an ejection unit that ejects the liquid;
a partition wall separating the first chamber and the second chamber from each other and provided with a through hole making the first chamber and the second chamber communicate with each other; and
a valve including (i) a body portion to be contained in the first chamber and (ii) a penetrating portion having an outer diameter smaller than an inner diameter of the through hole and provided in the body portion so as to penetrate through the through hole and extend to the inside of the second chamber,
wherein the valve is movable between an open position where a flow of the liquid through the through hole can be allowed and a restricted position where a flow of the liquid through the through hole can be restricted,
wherein, when La is a width of a gap between an outer peripheral surface of the penetrating portion and an inner wall surface of the through hole and Lb is a width of a gap between an outer peripheral surface of the body portion and an inner wall surface of the first chamber, La≥1.2×Lb is satisfied.

Further features of the present invention will become apparent from the following description of exemplary embodiments with reference to the attached drawings.

### BRIEF DESCRIPTION OF THE DRAWINGS

FIG. 1A is a diagram illustrating a liquid ejection apparatus;

FIG. 1B is a diagram illustrating the liquid ejection apparatus;

FIG. 2 is an exploded perspective view of a liquid ejection head;

FIG. 3A and FIG. 3B are a vertical cross section of the liquid ejection head and an enlarged cross-sectional view of an ejection module;

FIG. 4 is an external schematic diagram of a circulation unit;

FIG. 5 is a vertical cross-sectional view illustrating a circulation route;

FIG. 6 is a block diagram schematically illustrating a circulation route;

FIG. 7A to FIG. 7C are cross-sectional views each illustrating an example of a pressure adjustment unit;

FIG. 8A and FIG. 8B are external perspective views of a circulation pump;

FIG. 9 is a cross-sectional view of the circulation pump illustrated in FIG. 8A along a line IX-IX;

FIG. 10A to FIG. 10E are diagrams each illustrating ink flows in an ejection unit;

FIG. 11A is a schematic diagram illustrating a circulation route in the ejection unit;

FIG. 11B is a schematic diagram illustrating the circulation route in the ejection unit;

FIG. 12 is a diagram illustrating an aperture plate;

FIG. 13 is a diagram illustrating an ejection element substrate;

FIG. 14A to FIG. 14C are cross-sectional views illustrating ink flows in portions of an ejection unit;

FIG. 15A and FIG. 15B are cross-sectional views illustrating the vicinity of ejection ports;

FIG. 16A and FIG. 16B are cross-sectional views illustrating, as a comparative example, the vicinity of ejection ports;

FIG. 17 is a diagram illustrating, as a comparative example, an ejection element substrate;

FIG. 18A and FIG. 18B are diagrams illustrating a flow path configuration of a liquid ejection head;

FIG. 19 is a diagram illustrating a state of connection between a main body portion of a liquid ejection apparatus and the liquid ejection head;

FIG. 20A and FIG. 20B are illustrative views of a method of attaching the circulation unit to the liquid ejection head;

FIG. 21A is a perspective view of the circulation unit, while FIG. 21B and FIG. 21C are views along arrows IVb and IVc in FIG. 21A;

FIG. 22 is a cross-sectional view of a valve unit in a state where a negative pressure in a pressure chamber is low in a first embodiment;

FIG. 23 is a cross-sectional view of the valve unit in a state where the negative pressure in the pressure chamber is high in the first embodiment;

FIG. 24 is a cross-sectional view of the valve unit in a state where the negative pressure in the pressure chamber is at least a predetermined level in the first embodiment;

FIG. 25A is an illustrative view of the valve unit in the first embodiment;

FIG. 25B is an illustrative view of the valve unit in the first embodiment;

FIG. 26A and FIG. 26B are illustrative views of a case where an ink flow in the valve unit is reverse in the first embodiment;

FIG. 27A is a diagram illustrating assembly of a valve unit in a comparative example;

FIG. 27B is a diagram illustrating assembly of the valve unit in the comparative example;

FIG. 28A to FIG. 28C are diagrams illustrating the assembly of the valve unit in the comparative example;

FIG. 29A to FIG. 29C are diagrams illustrating an operation of the valve unit in the comparative example;

FIG. 30A is an illustrative view of a valve unit in a second embodiment;

FIG. 30B is an illustrative view of the valve unit in the second embodiment;

FIG. 31 is a cross-sectional view along a line VIII-VIII in FIG. 30A;

FIG. 32 is a cross-sectional view of a valve unit in a third embodiment;

FIG. 33 is a cross-sectional view of a valve unit in a fourth embodiment;

FIG. 34A and FIG. 34B are cross-sectional views of a valve unit in a fifth embodiment;

FIG. 35A is a cross-sectional view of a valve unit in a sixth embodiment;

FIG. 35B and FIG. 35C are cross-sectional views of the valve unit in the sixth embodiment;

FIG. 36A is a cross-sectional view of a valve unit in a modification of the sixth embodiment; and

FIG. 36B is a cross-sectional view of the valve unit in the modification of the sixth embodiment; and

FIG. 37 is a cross-sectional view of the valve unit in the modification of the sixth embodiment.

### DESCRIPTION OF THE EMBODIMENTS

Referring to the drawings, the following will illustratively describe modes for carrying out this invention in detail on the basis of embodiments. It should be noted that, unless particularly specified otherwise, the dimensions, materials, shapes, a relative arrangement, or the like of components described in the embodiments are not intended to limit the scope of this invention only thereto.

### Liquid Ejection Apparatus

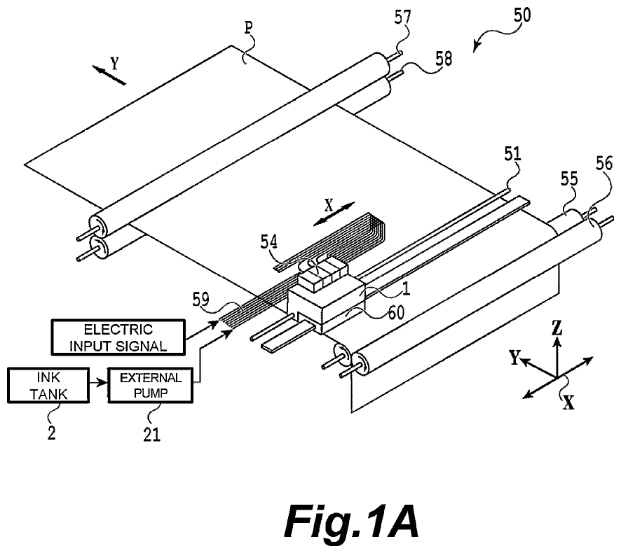

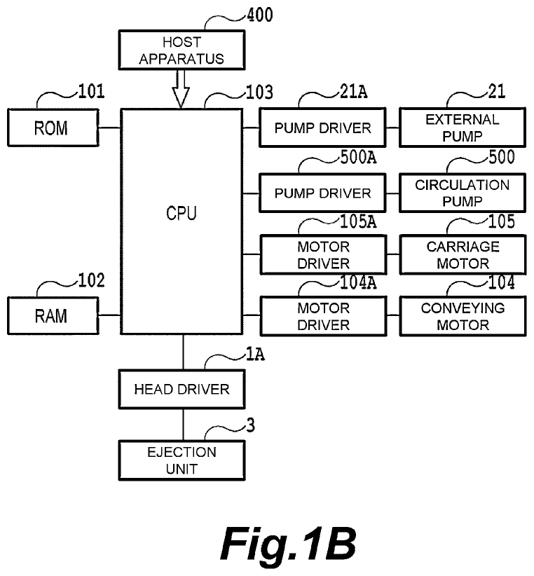

FIG. 1 is a diagram for illustrating the liquid ejection apparatus to which the present invention is applicable, which is an enlarged view of the liquid ejection and the periphery thereof in the liquid ejection apparatus. First, referring to FIG. 1, a schematic configuration of the liquid ejection apparatus 50 in the present embodiment will be described. FIG. 1 A is a perspective view schematically illustrating the liquid ejection apparatus using the liquid ejection head 1. The liquid ejection apparatus 50 in the present embodiment forms a serial-type inkjet recording apparatus that ejects the inks each as the liquid, while performing scanning with the liquid ejection head 1, to perform recording onto the recording sheet P.

The liquid ejection head 1 is mounted on the carriage 60. The carriage 60 reciprocates along the guide shaft 51 and along the main scanning direction (X-direction). The recording sheet P is conveyed in the sub-scanning direction (Y-direction) crossing (in the case of the present embodiment, perpendicular to) the main scanning direction by the conveying rollers 55, 56, 57, and 58. Note that, in each of the drawings referenced in the following, a Z-direction indicates a vertical direction crossing (in the case of the present embodiment, perpendicular to) an X-Y plane defined by the X-direction and the Y-direction. The liquid ejection head 1 is configured to be detachable and attachable from and to the carriage 60 by the user.

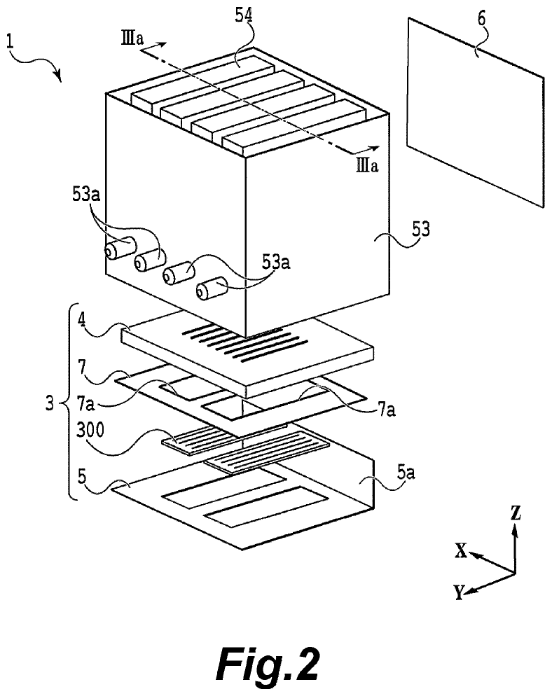

The liquid ejection head 1 is configured to include the circulation units 54 and an ejection unit 3 (see FIG. 2) described later. In the ejection unit 3, a plurality of ejection ports and an energy generation element (hereinafter referred to as the ejection element) that generates an ejection energy for ejection of a liquid from each of the ejection ports are provided, though a specific configuration thereof will be described later.

In addition, in the liquid ejection apparatus 50, the ink tanks 2 each serving as the ink supply source and the external pumps 21 are provided, and the inks stored in the ink tanks 2 are supplied by the drive forces of the external pumps 21 to the circulation units 54 via the ink supply tubes 59.

The liquid ejection apparatus 50 repeats recording scanning in which the liquid ejection heads 1 mounted on the carriage 60 eject the inks, while moving in the main scanning direction, to perform recording and a conveying operation of conveying the recording sheet P in the sub-scanning direction. Thus, a predetermined image is formed on the recording sheet P. Note that the liquid ejection head 1 in the present embodiment is capable of ejecting four types of inks in black (K), cyan (C), magenta (M), and yellow (Y) and recording a full-color image by using these inks. However, inks that can be ejected from the liquid ejection head 1 are not limited to the four types of inks mentioned above. The present disclosure is also applicable to the liquid ejection head for ejecting another type of ink. In other words, the types and number of the inks to be ejected from the liquid ejection heads are not limited.

Additionally, in the liquid ejection apparatus 50, at a position away from a conveyance path for the recording sheet P in the X-direction, a cap member (not shown) capable of covering an ejection port surface of each of the liquid ejection heads formed with the ejection ports is provided. The cap member covers the ejection port surface of the liquid ejection head 1 during a non-recording operation to be used for prevention of drying out of the ejection ports, protection thereof, an operation of sucking in the ink from the ejection ports, and the like.

While an example is shown in which the four circulation units 54 corresponding to the four types of inks are included in the liquid ejection head 1 illustrated in FIG. 1A, the circulation units 54 corresponding to types of liquids to be ejected need only to be included. Alternatively, the plurality of circulation units 54 may also be provided for the same type of liquid. In other words, the liquid ejection head 1 can be configured to include the one or more circulation units. It may also be possible to use a configuration that does not circulate all the four types of inks, but circulates at least one ink only.

FIG. 1B is a block diagram illustrating a control system of the liquid ejection apparatus 50. A CPU 103 performs a function of a control unit that controls an operation of each of the units of the liquid ejection apparatus 50 on the basis of a program for a processing procedure or the like stored in a ROM 101. A RAM 102 is used as a work area when the CPU 103 performs processing or the like. The CPU 103 receives image data from a host apparatus 400 outside the liquid ejection apparatus 50 to control a head driver 1A and control driving of ejection elements provided in the ejection unit 3. The CPU 103 also controls drivers for various actuators provided in the liquid ejection apparatus. For example, the CPU 103 controls a motor driver 105A for the carriage motor 105 for moving the carriage 60, a motor driver 104A for a conveyance motor 104 for conveying the recording sheet P, and the like. The CPU 103 further controls a pump driver 500A for driving a circulation pump 500 described later, pump drivers 21A for the external pumps 21, and the like. Note that FIG. 1B illustrates a mode in which processing of having received the image data from the host apparatus 400 is performed, but the processing may also be performed in the liquid ejection apparatus 50 without depending on the data from the host apparatus 400.

### Basic Configuration of Liquid Ejection Head

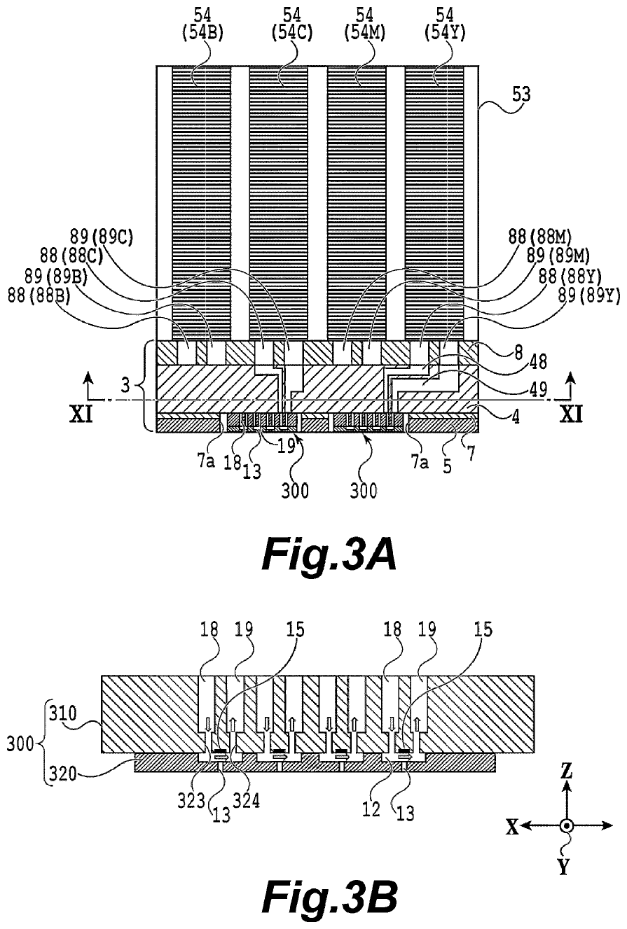

FIG. 2 is an exploded perspective view of each of the liquid ejection heads 1 in the present embodiment. FIG. 3A and FIG. 3B are cross-sectional views of the liquid ejection head 1 illustrated in FIG. 2 along a line IIIa-IIIa. FIG. 3A is an overall vertical cross-sectional view of the liquid ejection head 1, while FIG. 3B is an enlarged view of an ejection module illustrated in FIG. 3A. The following will describe a basic configuration of the liquid ejection head 1 in the present embodiment, while mainly referring to FIG. 2, FIG. 3A, and FIG. 3B and referring to FIG. 1 as appropriate.

As illustrated in FIG. 2, the liquid ejection head 1 is configured to include the circulation units 54 and the ejection unit 3 for ejecting the inks supplied from the circulation units 54 to the recording sheet P. The liquid ejection head 1 in the present embodiment is fixed to and supported by the carriage 60 via a positioning unit and an electric contact which are provided in the carriage 60 of the liquid ejection apparatus 50 and not shown. The liquid ejection head 1 ejects the ink, while moving together with the carriage 60 in the main scanning direction (X-direction) illustrated in FIG. 1, to perform recording on the recording sheet P.

In the external pumps 21 connected to the ink tanks 2 each serving as the ink supply source, the ink supply tubes 59 are provided (see FIG. 1). A leading end of each of the ink supply tubes 59 is provided with a liquid connector not shown. When the liquid ejection head 1 is mounted in the liquid ejection apparatus 50, to a liquid connector insertion port 53a provided in the head housing 53 of the liquid ejection head 1 to serve as an inlet port for the liquid, the liquid connector provided in the leading end of the ink supply tube 59 is hermetically connected. Thus, ink supply paths extending from the ink tanks 2 to reach the liquid ejection head 1 via the external pumps 21 are formed. In the present embodiment, the four types of inks are used, and accordingly four sets of the ink tanks 2, the external pumps 21, the ink supply tubes 59, and the circulation units 54 are provided to correspond to the individual inks, and the four ink supply paths corresponding to the individual inks are independently formed. Thus, in the liquid ejection apparatus 50 in the present embodiment, an ink supply system in which the inks are supplied from the ink tanks 2 provided outside the liquid ejection head 1 is included. Note that, in the liquid ejection apparatus 50 in the present embodiment, such an ink collection system as to collect the inks in the liquid ejection head 1 into the ink tanks 2 is not included. Consequently, in the liquid ejection head 1, the liquid connector insertion port 53a for connecting the ink supply tube 59 of each of the ink tanks 2 is provided, but a connection insertion port to which a tube for collecting the ink in the liquid ejection head 1 into the ink tank 2 is to be connected is not provided. Note that the liquid connector insertion port 53a is provided for each of the inks.

As illustrated in FIG. 3A and FIG. 3B, each of the circulation units 54 includes a circulation unit 54B for the black ink, a circulation unit 54C for the cyan ink, a circulation unit 54M for the magenta ink, and a circulation unit 54Y for the yellow ink. Each of the circulation units 54 has substantially the same configuration and, when the respective circulation units 54 are not particularly distinguished from each other in the present embodiment, signs indicating the colors or the like may be omitted.

In FIG. 2 and FIG. 3, the ejection unit 3 includes the two ejection modules 300, a first support member 4, a second support member 7, an electric wiring member (electric wiring tape) 5, and an electric contact substrate 6. As illustrated in FIG. 3, each of the ejection modules 300 includes a silicon substrate 310 having a thickness of 0.5 to 1 mm and a plurality of ejection elements 15 provided in one surface of the silicon substrate 310. Each of the ejection elements 15 in the present embodiment is formed of a thermoelectric conversion element (heater) that generates a thermal energy as the ejection energy for ejecting a liquid. To each of the ejection elements 15, electric power is supplied via electric wiring formed on the silicon substrate 310 by a deposition technique.

On a surface (lower surface in FIG. 3B) of the silicon substrate 310, an ejection port forming member 320 is formed. In the ejection port forming member 320, a plurality of pressure chambers 12 corresponding to the plurality of ejection elements 15 and a plurality of ejection ports 13 through which the inks are to be ejected are each formed by a photolithographic technique. Additionally, in the silicon substrate 310, common supply flow paths 18 and common collection flow paths 19 are formed. Moreover, in the silicon substrate 310, supply connection flow paths 323 providing communication between the common supply flow paths 18 and the individual pressure chambers 12 and collection connection flow paths 324 providing communication between the common collection flow paths 19 and the individual pressure chambers 12 are formed. In the present embodiment, each one of the ejection modules 300 is configured to eject the two types of inks. In other words, of the two ejection modules 300 illustrated in FIG. 3A, the ejection module 300 located on the left side of the drawing ejects the black ink and the cyan ink, and the ejection module 300 located on the right side of the drawing ejects the magenta ink and the yellow ink. Note that this combination is an example, and any combination of the inks is allowed. It may be possible that each one of the ejection modules is configured to eject one type of ink or configured to eject three or more types of inks. Each one of the two ejection modules 300 need not eject the same number of types of inks. It may be possible to use a configuration in which the one ejection module 300 is included or a configuration in which the three or more ejection modules 300 are included. In the example illustrated in FIG. 3A and FIG. 3B, two ejection port trains extending in the Y-direction are formed for one color ink. For each of the plurality of ejection ports 13 included in each of the ejection port trains, the pressure chamber 12, the supply connection flow path 323, and the collection connection flow path 324 are formed.

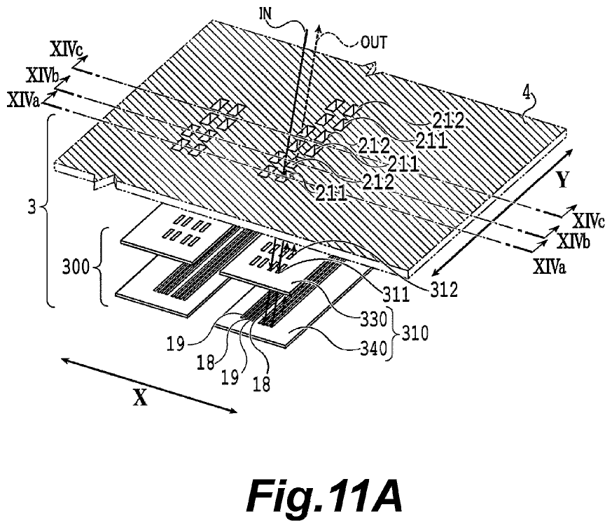

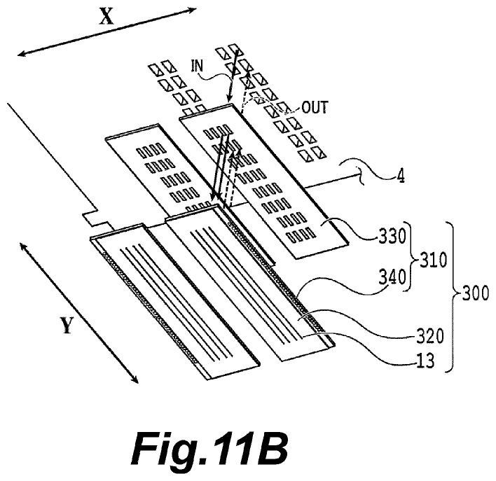

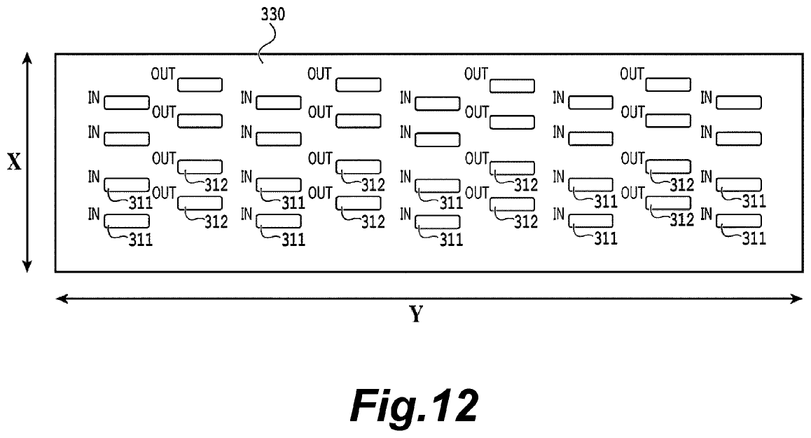

On a back surface (upper surface in FIG. 3B) side of the silicon substrate 310, the ink supply ports 311 and the ink collection ports 312, which will be described later, are formed (see FIG. 11A, FIG. 11B, and FIG. 12). The ink supply ports 311 supply the inks from ink supply flow paths 48 to the plurality of common supply flow paths 18, while the ink collection ports 312 collect the inks from the plurality of common collection flow paths 19 into ink collection flow paths 49.

Note that the ink supply ports 311 and the ink collection ports 312 each mentioned herein indicate openings through which the inks are supplied and collected during ink circulation in a forward direction, which will be described later. In other words, during the ink circulation in the forward direction, the inks are supplied from the ink supply ports 311 to the individual common supply flow paths 18, while the inks are collected from the individual common collection flow paths 19 to the ink collection ports 312. Meanwhile, ink circulation in which the inks are caused to flow in a reverse direction may also be performed. In this case, the inks are supplied from the ink collection ports 312 to the common collection flow paths 19, while the inks are collected from the common supply flow paths 18 to the ink supply ports 311.

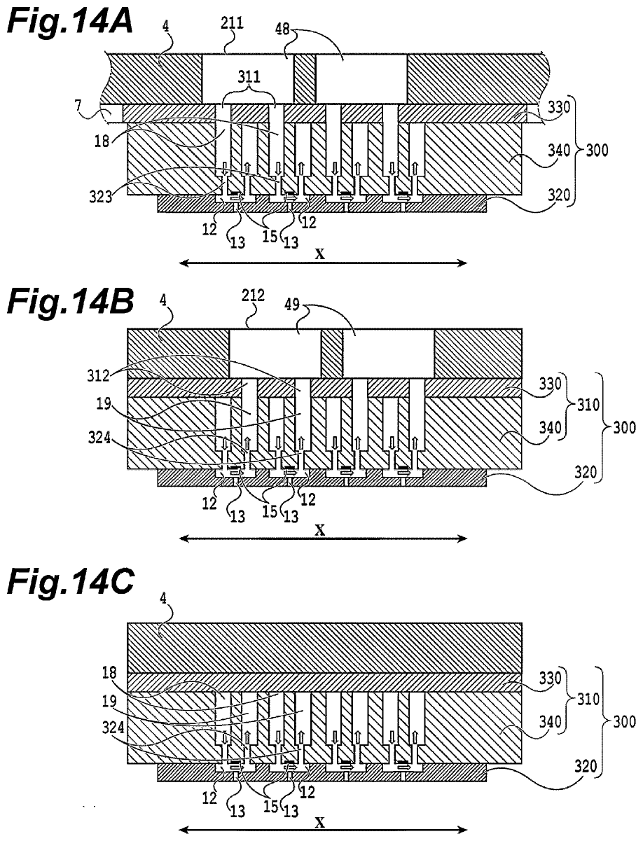

As illustrated in FIG. 3A, each of the ejection modules 300 has the back surface (upper surface in FIG. 3A) thereof which is adhesively fixed to one surface (lower surface in FIG. 14A) of the first support member 4. In the first support member 4, the ink supply flow paths 48 and the ink collection flow paths 49 are formed to extend therethrough from one surface thereof to another surface (upper surface in FIG. 3A) thereof. One opening of each of the ink supply flow paths 48 communicates with the ink supply port 311 described above in the silicon substrate 310, while one opening of each of the ink collection flow paths 49 communicates with the ink collection port 312 described above in the silicon substrate 310. Note that the ink supply flow paths 48 and the ink collection flow paths 49 are provided independently on a per ink type basis.

To one surface (upper surface in FIG. 3A) of the first support member 4, the second support member 7 having openings 7a (see FIG. 2) through which the ejection modules 300 are to be inserted is adhesively fixed. The second support member 7 holds the electric wiring member 5 to be electrically connected to the ejection modules 300. The electric wiring member 5 is a member for applying an electric signal for ejecting the inks to the ejection modules 300. An electrical connection portion between each of the ejection modules 300 and the electric wiring member 5 is sealed with a sealing material (not shown) to be protected from corrosion due to the inks or an external impact.

To an end portion 5a (see FIG. 2) of the electric wiring member 5, the electric contact substrate 6 is thermally compressed by using an anisotropic conductive film not shown to be electrically connected to the electric wiring member 5. The electric contact substrate 6 has an external signal input terminal (not shown) for receiving the electric signal from the liquid ejection apparatus 50.

In addition, between the first support member 4 and the circulation units 54, joint members 8 (FIG. 3A) are provided. In the joint members 8, supply ports 88 and collection ports 89 are formed on a per ink type basis. The supply ports 88 and the collection ports 89 provide communication between the ink supply flow paths 48 and the ink collection flow paths 49 of the first support member 4 and flow paths formed in the circulation units 54. Note that, in FIG. 3A, a supply port 88B and a collection port 89B correspond to the black ink, while a supply port 88C and a collection port 89C correspond to the cyan ink. A supply port 88M and a collection port 89M correspond to the magenta ink, while a supply port 88Y and a collection port 89Y correspond to the yellow ink.

Note that an opening in one end portion of each of the ink supply flow paths 48 and the ink collection flow paths 49 of the first support member 4 has a small aperture area corresponding to each of the ink supply ports 311 and the ink collection ports 312 in the silicon substrate 310. Meanwhile, an opening in another end portion of each of the ink supply flow paths 48 and the ink collection flow paths 49 of the first support member 4 has a shape obtained as a result of enlargement to the same aperture area as a large aperture area of each of the joint members 8 formed to correspond to the flow paths in the circulation units 54. By using such a configuration, it is possible to suppress an increase in a flow path resistance to the ink collected from each of the collection flow paths. Note that the shapes of the openings in the one end portion and the other end portion of each of the ink supply flow paths 48 and the ink collection flow paths 49 are not limited to those in the example described above.

In the liquid ejection head 1 having the configuration described above, the inks supplied to the circulation units 54 flow from the ink supply ports 311 of the ejection modules 300 into the common supply flow paths 18 through the supply ports 88 of the joint members 8 and the ink supply flow paths 48 in the first support member 4. Subsequently, the inks flow from the common supply flow paths 18 into the pressure chambers 12 via the supply connection flow paths 323, and portions of the inks having flown into the pressure chambers 12 are ejected from the ejection ports 13 by the driving of the ejection elements 15. The remaining inks that have not been ejected flow from the pressure chambers 12 through the collection connection flow paths 324 and the common collection flow paths 19 to flow into the ink collection flow paths 49 of the first support member 4 from the ink collection ports 312. Then, the inks that have flown into the ink collection flow paths 49 flow into the circulation units 54 through the collection ports 89 of the joint members 8 to be collected.

### Components of Circulation Unit

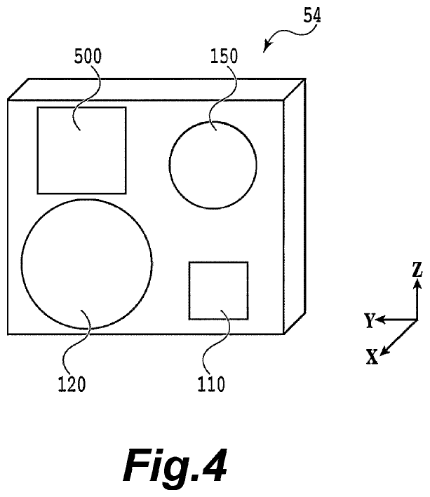

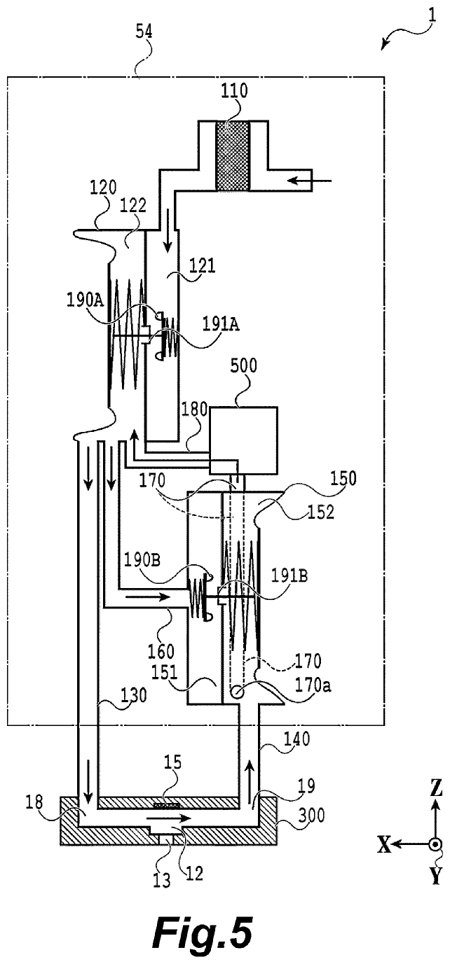

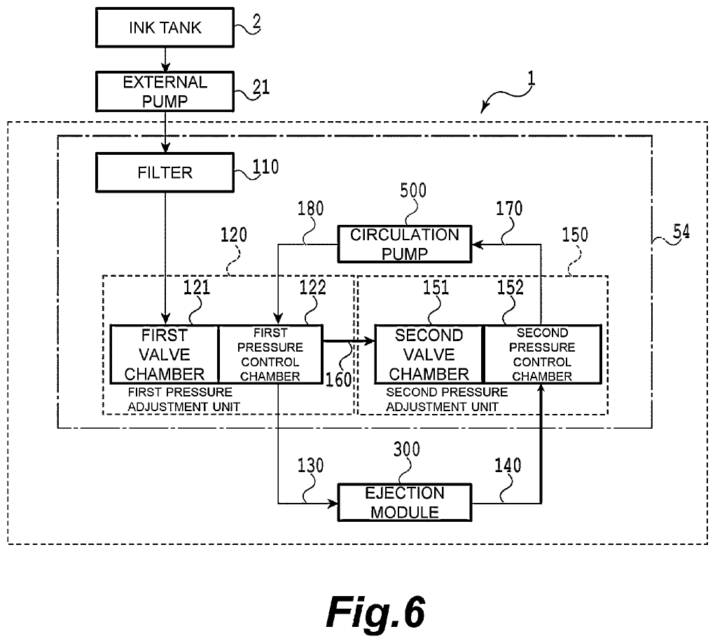

FIG. 4 is a schematic external view of one of the circulation units 54 corresponding to one type of ink, which is applied to the liquid ejection apparatus in the present embodiment. Preferably, each of the circulation units 54 has, in addition to the circulation pump 500, a filter 110, a first pressure adjustment unit 120, and a second pressure adjustment unit 150. These components are connected by the individual flow paths as illustrated in FIG. 5 and FIG. 6 to form a circulation route that supplies and collects the ink to and from the ejection module 300 in the liquid ejection head 1.

### Circulation Route in Liquid Ejection Head

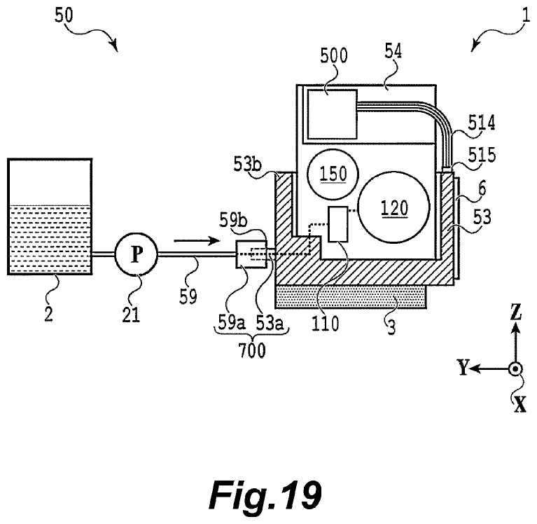

FIG. 5 is a vertical cross-sectional view schematically illustrating the circulation route of one type of ink (one color ink) formed in the liquid ejection head 1. For clearer illustration of the circulation route, relative positions of the individual components (such as the first pressure adjustment unit 120, the second pressure adjustment unit 150, and the circulation pump 500) in FIG. 5 are simplified. Accordingly, the relative positions of the individual components are different from those in a configuration in FIG. 19 described later. FIG. 6 is a block diagram schematically illustrating the circulation route illustrated in FIG. 5. As illustrated in FIG. 5 and FIG. 6, the first pressure adjustment unit 120 includes a first valve chamber 121 and a first pressure control chamber 122. The second pressure adjustment unit 150 includes a second valve chamber 151 and a second pressure control chamber 152. The first pressure adjustment unit 120 is configured to have a control pressure relatively higher than that of the second pressure adjustment unit 150. In the present embodiment, by using the two pressure adjustment units which are the first pressure adjustment unit 120 and the second pressure adjustment unit 150, circulation within a given pressure range is provided in the circulation route. Each of the pressure chambers 12 (ejection elements 15) is configured such that the ink flows therein at a flow rate corresponding to a pressure difference between the first pressure adjustment unit 120 and the second pressure adjustment unit 150. Referring to FIG. 5 and FIG. 6, the following will describe the circulation route and an ink flow in the circulation route in the liquid ejection head 1. Note that arrows in the individual drawings indicate directions in which the ink flows.

First, a state of connection between the individual components in the liquid ejection head 1 will be described. Each of the external pumps 21 that send the inks contained in the ink tanks 2 (FIG. 6) provided outside the liquid ejection head 1 to the liquid ejection head 1 is connected to the circulation unit 54 via the ink supply tube 59 (FIG. 1). In an ink flow path (inlet flow path) located on an upstream side of the circulation units 54, the filter 110 is provided. An ink supply path (inlet flow path) located on a downstream side of the filter 110 is connected to the first valve chamber 121 of the first pressure adjustment unit 120. The first valve chamber 121 communicates with the first pressure control chamber 122 via a communication port 191A openable/closable by a valve 190A illustrated in FIG. 5. Note that the inlet flow path is a flow path that allows the liquid inside the ink tank 2 provided outside the liquid ejection head 1 to flow into the liquid ejection head 1 and be supplied to the pressure chamber 12.

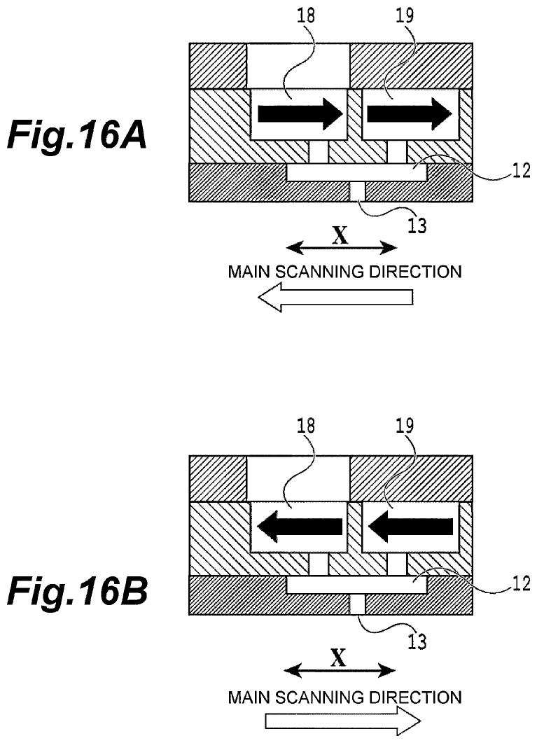

The first pressure control chamber 122 is connected to each of a supply flow path 130, a bypass flow path 160, and a pump outlet flow path 180 of the circulation pump 500. The supply flow path 130 is connected to the common supply flow path 18 via the ink supply port 311 described above, which is provided in the ejection module 300. Meanwhile, the bypass flow path 160 is connected to the second valve chamber 151 provided in the second pressure adjustment unit 150. The second valve chamber 151 communicates with the second pressure control chamber 152 via a communication port 191B opened/closed by a valve 190B illustrated in FIG. 16. In FIG. 5 and FIG. 6, an example is shown in which one end of the bypass flow path 160 is connected to the first pressure control chamber 122 of the first pressure adjustment unit 120, while another end of the bypass flow path 160 is connected to the second valve chamber 151 of the second pressure adjustment unit 150. By contrast, it may also be possible to connect the one end of the bypass flow path 160 to the supply flow path 130 and connect the other end of the bypass flow path to the second valve chamber 151.

The second pressure control chamber 152 is connected to a collection flow path 140. The collection flow path 140 is connected to the common collection flow path 19 via the ink collection port 312 described above, which is provided in the ejection module 300. The second pressure control chamber 152 is further connected to the circulation pump 500 via a pump inlet flow path 170. Note that the pump inlet flow path 170 is connected to the second pressure control chamber via an inlet port 170a.

Next, a description will be given of the ink flow in the liquid ejection head 1 having the configuration described above. As illustrated in FIG. 6, each of the inks contained in the ink tanks 2 is pressurized by the external pump 21 provided in the liquid ejection apparatus 50 to form a positive-pressure ink flow, which is supplied to the circulation unit 54 of the liquid ejection head 1.

The ink supplied to the circulation unit 54 passes through the filter 110 to have a foreign substance, such as dust, and air bubbles removed therefrom, and then flows into the first valve chamber 121 provided in the first pressure adjustment unit 120. A pressure loss at the time of the passage through the filter 110 reduces a pressure of the ink but, at this stage, the pressure of the ink is under a positive pressure. Then, when the valve 190A is in an open state, the ink that has flown in the first valve chamber 121 passes through the communication port 191A to flow into the first pressure control chamber 122. Due to a pressure loss at the time of the passage through the communication port 191A, the ink that has flown in the first pressure control chamber 122 changes from under the positive pressure to under a negative pressure.

Next, the ink flow in the circulation route will be described. The circulation pump 500 operates so as to feed out the ink sucked in from the pump inlet flow path 170 corresponding to an upstream side thereof into the pump outlet flow path 180 corresponding to a downstream side thereof. Accordingly, as a result of driving of the circulation pump 500, the ink supplied to the first pressure control chamber 122 flows together with the ink pumped out of the pump outlet flow path 180 into the supply flow path 130 and into the bypass flow path 160. Note that, in the present embodiment, as the circulation pump 500 capable of pumping, a piezoelectric diaphragm pump using a piezoelectric element bonded to a diaphragm as a drive source, which will be described later in detail, is used. The piezoelectric diaphragm pump is a pump that performs pumping by inputting a drive voltage to the piezoelectric element to change an inner cubic volume of a pump chamber and alternately move two check valves by using a pressure fluctuation.

The ink that has flown in the supply flow path 130 flows from the ink supply ports 311 of the ejection module 300 into the pressure chamber 12 via the common supply flow path 18, and a portion of the ink is ejected from the ejection port 13 by the driving of the ejection element 15 (heat generation). The remaining ink that has not been used for the ejection flows in the pressure chamber 12 and passes through the common collection flow path 19 to flow into the collection flow path 140 connected to the ejection module 300. The ink that has flown into the collection flow path 140 flows into the second pressure control chamber 152 of the second pressure adjustment unit 150.

Meanwhile, the ink that has flown from the first pressure control chamber 122 into the bypass flow path 160 flows into the second valve chamber 151, and then passes through the communication port 191B to flow into the second pressure control chamber 152. The ink that has flown into the second pressure control chamber 152 via the bypass flow path 160 and the ink collected from the collection flow path 140 are sucked into the circulation pump 500 through the pump inlet flow path 170 by the driving of the circulation pump 500. Then, the inks sucked into the circulation pump 500 are sent to the pump outlet flow path 180 to flow into the first pressure control chamber 122 again. Subsequently, the ink that has flown from the first pressure control chamber 122 into the second pressure control chamber 152 via the supply flow path 130 through the ejection module 300 and the ink that has flown into the second pressure control chamber 152 via the bypass flow path 160 flow into the circulation pump 500. Then, from the circulation pump 500, the inks are sent to the first pressure control chamber 122. Thus, the ink circulation is performed in the circulation route.

As described above, in the present embodiment, it is possible to use the circulation pump 500 to circulate a liquid along the circulation route formed in the liquid ejection head 1. As a result, it is possible to suppress an increased viscosity of the ink and deposition of a precipitating component of the ink corresponding to a color material in the ejection module 300 and maintain a flowability of the ink in the ejection module 300 and an ejection property thereof in the ejection port 13 in an excellent state.

Since the circulation route in the present embodiment is configured to be completed inside the liquid ejection head 1, a circulation route length can significantly be reduced compared to that in a case where the ink circulation is performed between the ink tank 2 provided outside the liquid ejection head and the liquid ejection head 1. As a result, the ink circulation can be performed in the small-size circulation pump 500.

In addition, the circulation route is also configured to include, as a connection flow path between the liquid ejection head 1 and the ink tank 2, only a flow path that supplies the ink. In other words, the circulation route has a configuration which does not need a flow path for collecting the ink from the liquid ejection head 1 to the ink tank 2. Accordingly, only the ink supply tube 59 needs to be provided to connect the ink tank 2 and the liquid ejection head 1, and a tube for ink collection need not be provided. This can provide the liquid ejection apparatus 50 with a simple inner configuration in which the number of tubes is reduced and achieve a size reduction of the entire liquid ejection apparatus 50. Moreover, the reduced number of the tubes can reduce a pressure fluctuation of the ink due to swing of the ink supply tubes 59 resulting from main scanning with the liquid ejection head 1. Additionally, the swing of the ink supply tubes 59 during the main scanning with the liquid ejection head 1 results in a drive load for the carriage motor 105 that drives the carriage 60. Accordingly, the reduced number of the tubes reduces the drive load for the carriage motor 105 to allow a main scanning mechanism including the carriage motor 105 and the like to be simplified. In addition, since collection of the ink from the liquid ejection head to the ink tank is unnecessary, the size of the external pump 21 can also be reduced. Thus, according to the present embodiment, it is possible to reduce the size and cost of the liquid ejection apparatus 50.

### Pressure Adjustment Unit

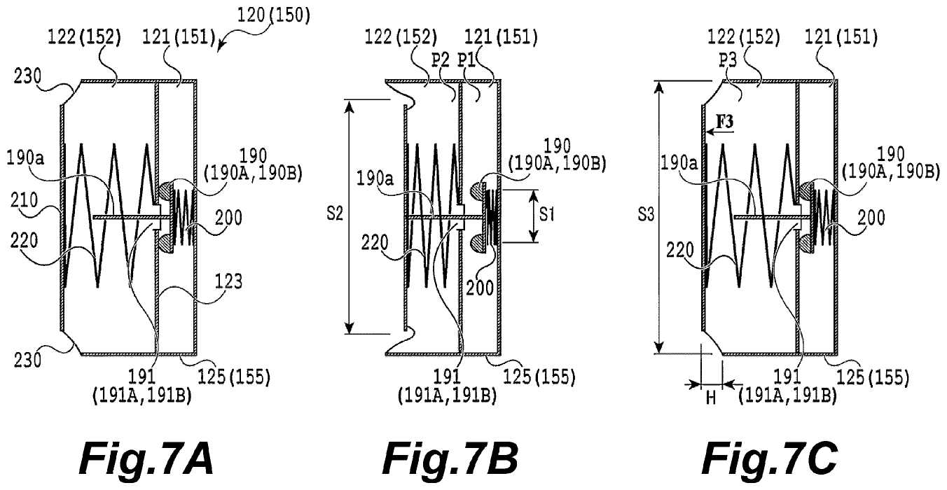

FIG. 7A to FIG. 7C are diagrams illustrating an example of a pressure adjustment unit. Referring to FIG. 7A to FIG. 7C, a configuration and an operation of the pressure adjustment unit (the first pressure adjustment unit 120 and the second pressure adjustment unit 150) embedded in the liquid ejection head 1 described above will be described in greater detail. Note that the first pressure adjustment unit 120 and the second pressure adjustment unit 150 have substantially the same configuration. Accordingly, the following description will be given by using the first pressure adjustment unit 120 as an example and, for the second pressure adjustment unit 150, reference signs are merely given to portions thereof corresponding to those of the first adjustment unit in FIG. 7A to FIG. 7C. In a case of the second pressure adjustment unit 150, it is assumed that the first valve chamber 121 described below is read as a second valve chamber 151, and the first pressure control chamber 122 is read as the second pressure control chamber 152.

The first pressure adjustment unit 120 has the first valve chamber 121 and the first pressure control chamber 122 which are formed in a cylindrical housing 125. The first valve chamber 121 and the first pressure control chamber 122 are separated by a partition wall 123 provided in the cylindrical housing 125. However, the first valve chamber 121 communicates with the first pressure control chamber 122 via a communication port 191 formed in the partition wall 123. In the first valve chamber 121, a valve 190 that switches the first valve chamber 121 and the first pressure control chamber 122 between communication and disconnection in the communication port 191 is provided. The valve 190 is held at a position facing the communication port 191 by a valve spring 200 and configured to be able to be brought into close contact with the partition wall 123 by a biasing force of the valve spring 200. The valve 190 is brought into close contact with the partition wall 123 to disconnect an ink flow in the communication port 191. Note that, to increase closeness of the contact with the partition wall 123, a portion of the valve 190 which is in contact with the partition wall 123 is preferably formed of an elastic member. Additionally, at a center portion of the valve 190, a valve shaft 190a is provided to protrude and be inserted through the communication port 191. By pressing the valve shaft 190a against the biasing force of the valve spring 200, the valve 190 is brought away from the partition wall 123 to allow the ink flow in the communication port 191. Hereinbelow, a state where the ink flow in the communication port 191 is disconnected by the valve 190 is referred to as a “closed state”, while a state where the ink flow in the communication port 191 is allowed is referred to as an “open state”.

An opening portion in the cylindrical housing 125 is closed by flexible members 230 and a pressure plate 210. The flexible members 230, the pressure plate 210, a peripheral wall of the housing 125, and the partition wall 123 form the first pressure control chamber 122. The pressure plate 210 is configured to be displaceable with displacement of the flexible members 230. Materials of the pressure plate 210 and the flexible members 230 are not particularly limited, and the pressure plate 210 can be formed of, e.g., a resin molded part, while the flexible members 230 can be formed of, e.g., a resin film. In this case, the pressure plate 210 can be fixed to the flexible members 230 by heat sealing.

Between the pressure plate 210 and the partition wall 123, a pressure adjustment spring 220 (biasing member) is provided. By a biasing force of the pressure adjustment spring 220, the pressure plate 210 and the flexible members 230 are biased in a direction in which an inner cubic volume of the first pressure control chamber 122 is increased, as illustrated in FIG. 7A. When a pressure in the first pressure control chamber 122 decreases, the pressure plate 210 and the flexible members 230 are displaced against the pressure of the pressure adjustment spring 220 in such a direction as to reduce the inner cubic volume of the first pressure control chamber 122. Then, when the inner cubic volume of the first pressure control chamber 122 decreases to a given amount, the pressure plate 210 comes into contact with the valve shaft 190a of the valve 190. Thereafter, when the inner cubic volume of the first pressure control chamber 122 further decreases, the valve 190 moves together with the valve shaft 190a against the biasing force of the valve spring 200 to move away from the partition wall 123. This brings the communication port 191 into the open state (state in FIG. 7B).

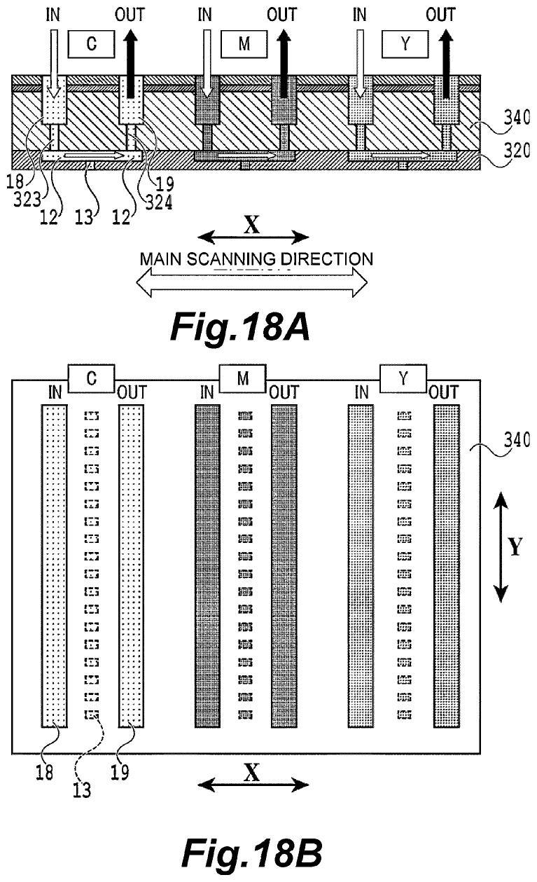

In the present embodiment, connections in the circulation route are set such that a pressure in the first valve chamber 121 when the communication port 191 is brought into the open state is higher than the pressure in the first pressure control chamber 122. As a result, when the communication port 191 is brought into the open state, the ink flows from the first valve chamber 121 into the first pressure control chamber 122. The inflow of the ink displaces the flexible members 230 and the pressure plate 210 in such a direction as to increase the inner cubic volume of the first pressure control chamber 122. As a result, the pressure plate 210 moves away from the valve shaft 190a of the valve 190, and the valve 190 is brought into close contact with the partition wall 123 by the biasing force of the valve spring 200 to bring the communication port 191 into the closed state (state in FIG. 18C).

Thus, in the first pressure adjustment unit 120 in the present embodiment, when the pressure in the first pressure control chamber 122 decreases to a given pressure or less (e.g., when a negative pressure increases), the ink flows in from the first valve chamber 121 via the communication port 191. Thus, the first pressure control chamber 122 is configured so as to prevent the pressure therein from further decreasing. Therefore, the first pressure control chamber 122 is controlled so as to be held under a pressure within a given range.

Next, a more detailed description will be given of the pressure in the first pressure control chamber 122. A consideration will be given to a state (state in FIG. 7B) where, as described above, the flexible members 230 and the pressure plate 210 are displaced according to the pressure in the first pressure control chamber 122, and the pressure plate 210 has come into contact with the valve shaft 190a to bring the communication port 191 into the open state. At this time, a relationship between forces acting on the pressure plate 210 is represented by Expression 1 shown below:

$$P 2 \times S 2 + F 2 + ( P 1 - P 2 ) \times S 1 + F 1 = 0 . \qquad Expression 1$$

When Expression 1 is rearranged with respect to P2, Expression 2 is obtained:

$$P 2 = - ( F 1 + F 2 + P 1 \times S 1 ) / ( S 2 - S 1 ) \qquad Expression 2$$

where P1 is a pressure (gauge pressure) in the first valve chamber 121, P2 is a pressure (gauge pressure) in the first pressure control chamber 122, F1 is a spring force of the valve spring 200, F2 is a spring force of the pressure adjustment spring 220, S1 is a pressure receiving area of the valve 190, and S2 is a pressure receiving area of the pressure plate 210.

It is assumed herein that a direction in which the valve 190 and the pressure plate 210 are pressed is a positive direction (leftward direction in FIG. 7A to FIG. 7C) of each of the spring force F1 of the valve spring 200 and the spring force F2 of the pressure adjustment spring 220. In addition, with regard to the pressure P1 in the first valve chamber 121 and the pressure P2 in the first pressure control chamber 122, P1 is configured to satisfy a relationship given by P1≥P2.

The pressure P2 in the first pressure control chamber 122 when the communication port 191 is in the open state is determined by Expression 2 and, when the communication port 191 is brought into the open state, due to a configuration where the relationship given by P1≥P2 is satisfied, the ink flows from the first valve chamber 121 into the first pressure control chamber 122. As a result, the pressure P2 in the first pressure control chamber 122 is prevented from further decreasing, and P2 is held at a pressure within a given range.

Meanwhile, as illustrated in FIG. 7C, a relationship between forces acting on the pressure plate 210 when the pressure plate 210 is brought into non-contact with the valve shaft 190a and the communication port 191 is brought into the closed state is given by Expression 3:

$$P 3 \times S 3 + F 3 = 0 . \qquad Expression 3$$

When Expression 3 is rearranged with respect to P3, Expression 4 is obtained.

$$P 3 = - F 3 / S 3 \qquad Expression 4$$

wherein F3 is a spring force of the pressure adjustment spring 220 when the pressure plate 210 and the valve shafts 190a are in a non-contact state, P3 is a pressure (gauge pressure) in the first pressure control chamber 122 when the pressure plate 210 and the valve shaft 190a are in the non-contact state, and S3 is a pressure receiving area of the pressure plate 210 when the pressure plate 210 and the valve 190 are in the non-contact state.

It is to be noted herein that FIG. 7C illustrates a state where the pressure plate 210 and the flexible members 230 are displaced in the leftward direction in the drawing up to a limit which allows the pressure plate 210 and the flexible members 230 to be displaced. Depending on a displacement amount during the displacement of the pressure plate 210 and the flexible members 230 into a state in FIG. 7C, the pressure P3 in the first pressure control chamber 122, the spring force F3 of the pressure adjustment spring 220, and the pressure receiving area S3 of the pressure plate 210 change. Specifically, when the pressure plate 210 and the flexible members 230 in FIG. 7B are more rightward than those in FIG. 7C, the pressure receiving area S3 of the pressure plate 210 is smaller, while the spring force F3 of the pressure adjustment spring 220 is larger. As a result, according to the relationship given by Expression 4, the pressure P3 in the first pressure control chamber 122 is reduced. Accordingly, according to Expression 2 and Expression 4, the pressure in the first pressure control chamber 122 gradually increases (i.e., the negative pressure decreases to have a value closer to a positive pressure side) during a period during which the state in FIG. 7B shifts to the state in FIG. 7C. In other words, from a state where the communication port 191 is in the open state, the pressure plate 210 and the flexible members 230 are gradually displaced leftward and, before the inner cubic volume of the first pressure control chamber 122 eventually reaches the limit which allows the pressure plate 210 and the flexible members 230 to be displaced, the pressure in the first pressure control chamber gradually increases. In other words, the negative pressure decreases.

### Circulation Pump

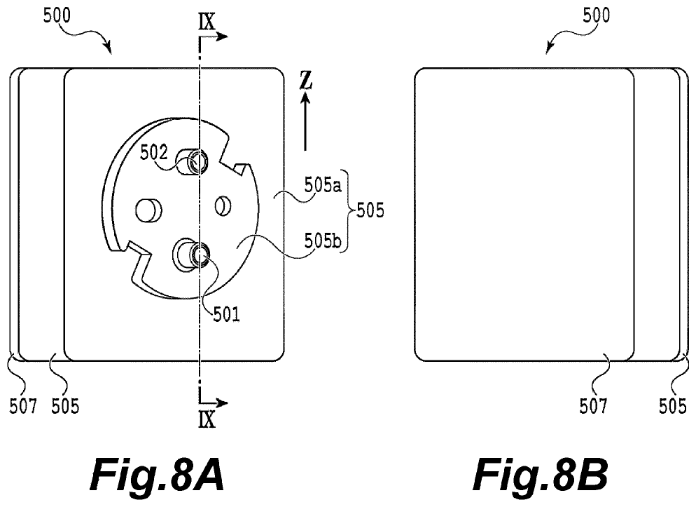

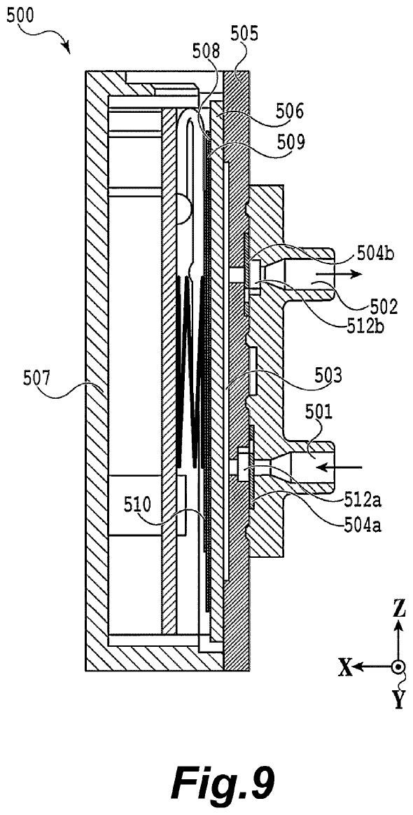

Next, referring to FIG. 8A, FIG. 8B, and FIG. 9, a configuration and an operation of each of the circulation pumps 500 embedded in the liquid ejection head 1 described above will be described in detail.

FIG. 18 and FIG. 8B are external perspective views of the circulation pump 500. FIG. 8A is an external perspective view of the circulation pump 500 illustrating a front side thereof, while FIG. 19B is an external perspective view of the circulation pump 500 illustrating a rear side thereof. An outer body of the circulation pump 500 includes a pump housing 505 and a cover 507 fixed to the pump housing 505. The pump housing 505 includes a housing portion main body 505a and a flow path connection member 505b adhesively fixed to an outer surface of the housing portion main body 505a. In each of the housing portion main body 505a and the flow path connection member 505b, a pair of through holes communicating with each other are provided at each of two different positions. The pair of through holes provided at one of the positions form a pump supply hole 501, while the pair of through holes provided at another of the positions form a pump discharge hole 502. The pump supply hole 501 is connected to the pump inlet flow path 170 connected to the second pressure control chamber 152, while the pump discharge hole 502 is connected to the pump outlet flow path 180 connected to the first pressure control chamber 122. The ink supplied from the pump supply hole 501 passes through a pump chamber 503 (see FIG. 90) described later to be discharged from the pump discharge hole 502.

FIG. 9 is a cross-sectional view of the circulation pump 500 illustrated in FIG. 8A along a line IX-IX. To an inner surface of the pump housing 505, a diaphragm 506 is bonded and, between the diaphragm 506 and a depressed portion formed in the inner surface of the pump housing 505, the pump chamber 503 is formed. The pump chamber 503 communicates with each of the pump supply hole 501 and the pump discharge hole 502 which are formed in the pump housing 505. In addition, in a middle portion of the pump supply hole 501, a check valve 504a is provided while, in a middle portion of the pump discharge hole 502, a check valve 504b is provided. Specifically, the check valve 504a is disposed such that a portion thereof can move leftward in the drawing in a space 512a formed in the middle portion of the pump supply hole 501. Meanwhile, the check valve 504b is disposed such that a portion thereof can move rightward in the drawing in a space 512b formed in the middle portion of the pump discharge hole 502.

When the diaphragm 506 is displaced to increase a cubic volume of the pump chamber 503 and depressurize the pump chamber 503, the check valve 504a moves away from an opening of the pump supply hole 501 in the space 512a (i.e., moves leftward in the drawing). As a result of the moving away of the check valve 504a from the opening of the pump supply hole 501 in the space 512a, the open state which allows an ink flow in the pump supply hole 501 is established. Meanwhile, when the diaphragm 506 is displaced to reduce the cubic volume of the pump chamber 503 and pressurize the pump chamber 503, the check valve 504a comes into close contact with a wall surface of the pump supply hole 501 around the opening thereof. As a result, the closed state which cuts off an ink flow in the pump supply hole 501 is established.

Meanwhile, when the pump chamber 503 is depressurized, the check valve 504b comes into close contact with a wall surface of the pump housing 505 around an opening thereof to provide the closed state which cuts off the ink flow in the pump discharge hole 502. When the pump chamber 503 is pressurized, the check valve 504b moves away from the opening of the pump housing 505 toward the space 512b side (i.e., moves rightward in the drawing) to allow the ink flow in the pump discharge hole 502.

Note that a material of each of the check valves 504a and 504b needs only to be deformable according to a pressure in the pump chamber 503, and each of the check valves 504a and 504b can be formed of, e.g., an elastic member made of EPDM, elastomer, or the like or a film or a thin plate made of polypropylene or the like. However, the material of each of the check valves 504a and 504b is not limited thereto.

As described above, the pump chamber 503 is formed by bonding together of the pump housing 505 and the diaphragm 506. As a result, deformation of the diaphragm 506 changes a pressure in the pump chamber 503. For example, when the diaphragm 506 is displaced toward the pump housing 505 side (displaced rightward in the drawing) to reduce the cubic volume of the pump chamber 503, the pressure in the pump chamber 503 increases. This brings the check valve 504b disposed to face the pump discharge hole 502 into the open state, and the ink in the pump chamber 503 is discharged. At this time, the check valve 504a disposed to face the pump supply hole 501 comes into close contact with the peripheral wall surface of the pump supply hole 501, and consequently a reverse flow of the ink from the pump chamber 503 into the pump supply hole 501 is suppressed.

Conversely, when the diaphragm 506 is displaced in a direction which expands the pump chamber 503, the pressure in the pump chamber 503 decreases. This brings the check valve 504a disposed to face the pump supply hole 501 into the open state, and the ink is supplied to the pump chamber 503. At this time, the check valve 504b disposed in the pump discharge hole 502 comes into close contact with the peripheral wall surface of the opening formed in the pump housing 505 to close the opening. Consequently, a reverse flow of the ink from the pump discharge hole 502 into the pump chamber 503 is suppressed.

Thus, in the circulation pump 500, the diaphragm 506 is deformed to change the pressure in the pump chamber 503 and thereby suck in and discharge the ink. At this time, when bubbles enter the pump chamber 503 in mixed relation, even though the diaphragm 506 is displaced, expansion/contraction of the bubbles reduces a pressure change in the pump chamber 503 to reduce an amount of pumping. Accordingly, the pump chamber 503 is disposed in parallel to a gravity force to allow the bubbles that have entered the pump chamber 503 in mixed relation to easily collect in an upper portion of the pump chamber 503, while the pump discharge hole 502 is disposed above a center of the pump chamber 503. Thus, it is possible to improve dischargeability of the bubbles in the pump and stabilize a flow rate.

### Ink Flow in Liquid Ejection Head

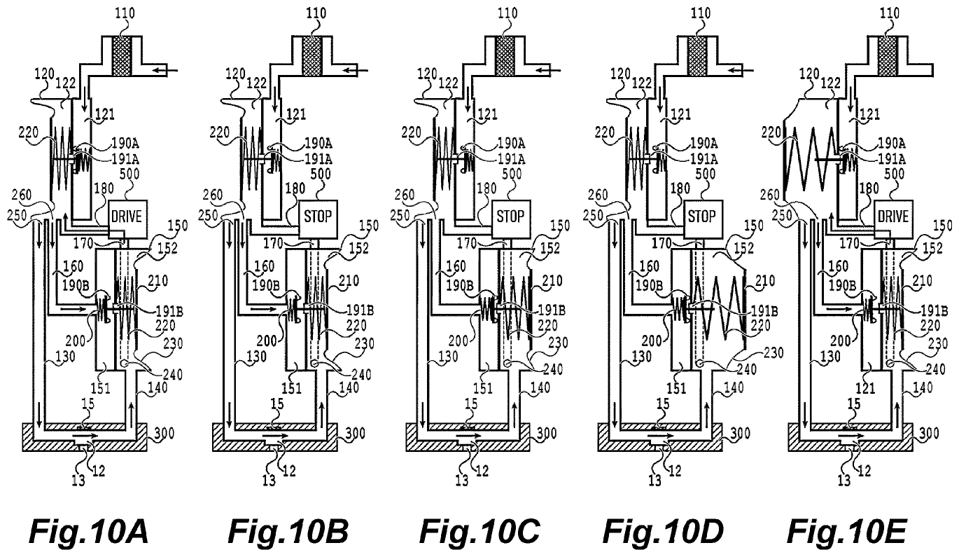

FIG. 10A to FIG. 10E are diagrams illustrating ink flows in the liquid ejection head. Referring to FIG. 10A to FIG. 10E, a description will be given of the ink circulation performed in the liquid ejection head 1. For clearer illustration of an ink circulation route, relative positions of the individual components (such as the first pressure adjustment unit 120, the second pressure adjustment unit 150, and the circulation pump 500) in FIG. 10A to FIG. 10E are simplified. Accordingly, the relative positions of the individual components are different from those in a configuration in FIG. 19, which will be described later. FIG. 10A schematically illustrates the ink flow when a recording operation of ejecting the ink from the ejection port 13 to perform recording is performed. Note that arrows in the drawings indicate the ink flows. In the present embodiment, when the recording operation is performed, both the external pump 21 and the circulation pump 500 start to be driven. It may also be possible that, irrespective of the recording operation, the external pump 21 and the circulation pump 500 are driven. The driving of the external pump 21 and the driving of the circulation pump 500 need not be performed in conjunction with each other, and the external pump 21 and the circulation pump 500 may also be driven independently and separately.

During the recording operation, the circulation pump 500 is in an ON state (driven state), and the ink that has flown in from the first pressure control chamber 122 flows into the supply flow path 130 and into the bypass flow path 160. The ink that has flown into the supply flow path 130 passes through the ejection module 300, and then flows into the collection flow path 140 to be subsequently supplied to the second pressure control chamber 152. Note that the supply flow path 130 is connected to the first pressure control chamber 122 via an opening portion 250, the bypass flow path 160 is connected to the first pressure control chamber 122 via an opening portion 260, and the collection flow path 140 is connected to the second pressure control chamber 152 via an opening portion 240.

Meanwhile, the ink that has flown from the first pressure control chamber 122 into the bypass flow path 160 flows into the second pressure control chamber 152 through the second valve chamber 151. The ink that has flown into the second pressure control chamber 152 passes through the pump inlet flow path 170, the circulation pump 500, and the pump outlet flow path 180 to subsequently flow into the first pressure control chamber 122 again. At this time, a control pressure due to the first valve chamber 121 is set higher than a control pressure in the first pressure control chamber 122 on the basis of the relationship given by Expression 2 described above. Consequently, the ink in the first pressure control chamber 122 is supplied again to the ejection module 300 via the supply flow path 130 instead of flowing into the first valve chamber 121. The ink that has flown into the ejection module 300 flows again into the first pressure control chamber 122 through the collection flow path 140, the second pressure control chamber 152, the pump inlet flow path 170, the circulation pump 500, and the pump outlet flow path 180. Thus, the ink circulation completed in the liquid ejection head 1 is performed.

In the foregoing ink circulation, an amount of the circulation (flow rate) of the ink in the ejection module 300 is determined by a pressure difference between the control pressures in the first pressure control chamber 122 and the second pressure control chamber 152. This pressure difference is set so as to provide an amount of circulation that can suppress an increased viscosity of the ink in the vicinity of the ejection ports in the ejection module 300. In addition, the ink corresponding to the ink consumed by recording is supplied from the ink tank 2 to the first pressure control chamber 122 via the filter 110 and the first valve chamber 121. A mechanism by which the ink corresponding to the consumed ink is supplied will be described in detail. In the circulation route, the ink decreases by the ink consumed by the recording to reduce the pressure in the first pressure control chamber and consequently reduce the ink in the first pressure control chamber 122. With the decrease of the ink in the first pressure control chamber 122, the inner cubic volume of the first pressure control chamber 122 also decreases. The decrease of the inner cubic volume of the first pressure control chamber 122 brings the communication port 191A into the open state, and the ink is supplied from the first valve chamber 121 into the first pressure control chamber 122. When the supplied ink passes from the first valve chamber 121 through the communication port 191A, a pressure loss occurs therein and, as a result of the inflow of the ink into the first pressure control chamber 122, the positive-pressure ink shifts to a negative-pressure state. Then, the ink flows from the first valve chamber 121 into the first pressure control chamber 122 to increase the pressure in the first pressure control chamber 122 and thereby increase the inner capacity of the first pressure control chamber 122 and bring the communication port 191A into the closed state. Thus, according to the consumption of the ink, the communication port 191A is repeatedly brought into the open state and the closed state. When the ink is not consumed, the communication port 191A is maintained in the closed state.

FIG. 10B schematically illustrates the ink flow immediately after the recording operation ended and the circulation pump 500 was brought into an OFF state (halt state). At a time point when the recording operation ended and the circulation pump 500 was turned OFF, each of the pressure in the first pressure control chamber 122 and the pressure in the second pressure control chamber 152 corresponds to the control pressure during the recording operation. Consequently, according to the pressure difference between the pressure in the first pressure control chamber 122 and the pressure in the second pressure control chamber 152, movement of the ink as illustrated in FIG. 10B occurs. Specifically, the ink is supplied from the first pressure control chamber 122 to the ejection module 300 via the supply flow path 130, and then an ink flow reaching the second pressure control chamber 152 through the collection flow path 140 is continuously generated. Additionally, an ink flow reaching the second pressure control chamber 152 from the first pressure control chamber 122 through the bypass flow path 160 and the second valve chamber 151 is also continuously generated.

The amount of the ink that has moved in these ink flows from the first pressure control chamber 122 to the second pressure control chamber 152 is supplied from the ink tank 2 to the first pressure control chamber 122 through the filter 110 and the first valve chamber 121. As a result, an inner volume of the first pressure control chamber 122 is held constant. According to the relationship given by Expression 2 described above, when the inner volume of the first pressure control chamber 122 is constant, the spring force F1 of the valve spring 200, the spring force F2 of the pressure adjustment spring 220, the pressure receiving area S1 of the valve 190, and the pressure receiving area S2 of the pressure plate 210 are held constant. Consequently, the pressure in the first pressure control chamber 122 is determined according to a change in the pressure (gauge pressure) P1 in the first valve chamber 121. As a result, when there is no change in the pressure P1 in the first valve chamber 121, the pressure P2 in the first pressure control chamber 122 is held at the same pressure as the control pressure during the recording operation.

Meanwhile, the pressure in the second pressure control chamber 152 changes with time according to a change in the amount of the content resulting from the inflow of the ink from the first pressure control chamber 122. Specifically, during a period before the communication port 191B in the state in FIG. 10B shifts to the closed state to bring the second valve chamber 151 and the second pressure control chamber 152 into a non-communicative state as illustrated in FIG. 10C, the pressure in the second pressure control chamber 152 changes according to Expression 2. Then, the pressure plate 210 and the valve shaft 190a are brought into a non-contact state to bring the communication port 191 into the closed state. Then, as illustrated in FIG. 10D, the ink flows from the collection flow path 140 into the second pressure control chamber 152. This ink inflow displaces the pressure plate 210 and the flexible members 230 and, during a period before the inner volume of the second pressure control chamber 152 reaches a maximum, the pressure in the second pressure control chamber 152 changes, i.e., increases, according to Expression 4.

Note that, when the state in FIG. 10C is reached, an ink flow extending from the first pressure control chamber 122 to reach the second pressure control chamber 152 through the bypass flow path 160 and the second valve chamber 151 is not generated. Consequently, after the ink in the first pressure control chamber 122 is supplied to the ejection module 300 via the supply flow path 130, only a flow reaching the second pressure control chamber 152 through the collection flow path 140 is formed. As described above, the movement of the ink from the first pressure control chamber 122 to the second pressure control chamber 152 occurs according to the pressure difference between the pressure in the first pressure control chamber 122 and the pressure in the second pressure control chamber 152. Accordingly, when the pressure in the second pressure control chamber 152 becomes equal to the pressure in the first pressure control chamber 122, the movement of the ink stops.

Additionally, in a state where the pressure in the second pressure control chamber 152 is equal to the pressure in the first pressure control chamber 122, the second pressure control chamber 152 expands to a state illustrated in FIG. 10D. When the second pressure control chamber 152 has expanded as illustrated in FIG. 10D, in the second pressure control chamber 152, a reservoir portion in which the ink can be reserved is formed. Note that a shift from the stop of the circulation pump 500 to the state in FIG. 10D takes a time of approximately 1 to 2 minutes, though the time may vary depending on the shape and size of the flow path and on a property of the ink. When the circulation pump 500 is driven in the state illustrated in FIG. 10D where the ink is reserved in the reservoir portion, the ink in the reservoir portion is supplied by the circulation pump 500 to the first pressure control chamber 122. This increases the amount of the ink in the first pressure control chamber 122 as illustrated in FIG. 10E, and the flexible members 230 and the pressure plate 210 are displaced in an expansion direction. Then, when the driving of the circulation pump 500 is continuously performed, as illustrated in FIG. 10A, a state in the circulation route changes.

Note that the foregoing description has been given as an example during the recording operation in FIG. 10A, the ink may also be circulated without involving the recording operation, as described above. In this case also, in response to the driving and stopping of the circulation pump 500, ink flows as illustrated in FIG. 10A to FIG. 10E are formed.

As also described above, in the present embodiment, the example is used in which the communication port 191B in the second pressure adjustment unit 150 is brought into the open state when the circulation pump 500 is driven to circulate the ink, and is brought into the closed state when the circulation of the ink stops, but the communication port 191B is not limited thereto. The control pressure may also be set such that the communication port 191B in the second pressure adjustment unit 150 stays in the closed state even when the circulation pump 500 is driven to circulate the ink. The following will give a specific description thereof in conjunction with that of a role of the bypass flow path 160.

The bypass flow path 160 connecting the first pressure adjustment unit 120 and the second pressure adjustment unit 150 is provided so as to prevent, when, e.g., a negative pressure formed in the circulation route increases to be higher than a prescribed value, the ejection module 300 from being affected thereby. The bypass flow path 160 is also provided so as to supply the ink to the pressure chamber 12 from both sides, i.e., from the supply flow path 130 and the collection flow path 140.

First, a description will be given of an example in which, when the negative pressure increases to be higher than the prescribed value, by providing the bypass flow path 160, the ejection module 300 is prevented from being affected thereby. For example, due to an ambient temperature change, a property (e.g., viscosity) of the ink may change. When the viscosity of the ink changes, the pressure loss in the circulation route also changes. For example, when the viscosity of the ink decreases, the pressure loss in the circulation route decreases. As a result, the flow rate in the circulation pump 500 driven in a given amount of driving increases to increase the flow rate of the ink flowing in the ejection module 300. Meanwhile, since the ejection module 300 is held at a given temperature by a temperature adjustment mechanism not shown, the viscosity of the ink in the ejection module 300 is maintained constant even when the ambient temperature changes. Since the flow rate of the ink flowing in the ejection module 300 increases while the viscosity of the ink in the ejection module 300 remains unchanged, a flow resistance accordingly increases the negative pressure in the ejection module 300. When the negative pressure in the ejection module 300 thus increases to be higher than the prescribed value, there is a risk that a meniscus of the ejection port 13 is destroyed, external air is drawn into the circulation route, and normal ejection cannot be performed. Even when the meniscus is not destroyed, the negative pressure in the pressure chamber 12 may increase to be higher than a predetermined value to affect the ejection.

To prevent this, in the present embodiment, the bypass flow path 160 is formed in the circulation route. By providing the bypass flow path 160, the ink flows also in the bypass flow path 160 when the negative pressure increases to be higher than the prescribed value, and accordingly it is possible to hold the pressure in the ejection module 300 constant. Therefore, e.g., the communication port 191B in the second pressure adjustment unit 150 may also be configured to have a control pressure which allows the closed state to be maintained even when the circulation pump 500 is being driven. Then, when the negative pressure increases to be higher than the prescribed value, the control pressure in the second pressure adjustment unit may also be set so as to bring the communication port 191 in the second pressure adjustment unit 150 into the open state. In other words, as long as the meniscus is not destroyed even by a flow rate change in the pump due to a viscosity change resulting from an ambient change or the like or the predetermined negative pressure is maintained, when the circulation pump 500 is driven, the communication port 191B may be in the closed state.

Next, an example will be described in which the bypass flow path 160 is provided so as to supply the ink to the pressure chamber 12 from both sides, i.e., from the supply flow path 130 and the collection flow path 140. A pressure change in the circulation route may be caused even by an ejecting operation by the ejection element 15. This is because, with the ejecting operation, a force to draw the ink into the pressure chamber 12 is generated.

The following will describe why the ink to be supplied to the pressure chamber 12 is supplied from both sides, i.e., from the supply flow path 130 side and the collection flow path 140 side when high-duty recording is to be continued. Note that a definition of a duty may vary depending on various conditions, but it is assumed herein that a state where one-shot recording is performed on a 1200 dpi grid using 4 μl of ink droplets corresponds to 100%. It is assumed that the high-duty recording is recording performed with, e.g., a 100% duty.

When the high-duty recording is continued, an amount of the ink that flows from the pressure chamber 12 into the second pressure control chamber 152 through the collection flow path 140 decreases. Meanwhile, since the circulation pump 500 performs outflow of the ink in a given amount, a balance between inflow and outflow in the second pressure control chamber 152 is lost, and the ink in the second pressure control chamber 152 decreases to increase the negative pressure in the second pressure control chamber 152 and reduce a size of the second pressure control chamber 152. The increased negative pressure in the second pressure control chamber 152 increases an inflow amount of the ink that flows into the second pressure control chamber 152 via the bypass flow path 160 to stabilize the second pressure control chamber 152 in a state where the inflow and the outflow are balanced. Thus, the negative pressure in the second pressure control chamber 152 resultantly increases according to the duty. Additionally, as described above, in a configuration in which the communication port 191B is in the closed state when the circulation pump 500 is driven, the communication port 191B is brought into the open state according to the duty, and the ink flows from the bypass flow path 160 into the second pressure control chamber 152.

Then, when the high-duty recording is further continued, the amount of the ink that flows from the pressure chamber 12 into the second pressure control chamber 152 through the collection flow path 140 decreases, while the amount of the ink that flows from the communication port 191B into the second pressure control chamber 152 via the bypass flow path 160 increases. When this state further proceeds, the amount of the ink that flows from the pressure chamber 12 into the second pressure control chamber 152 through the collection flow path 140 becomes zero, and all the ink that flows out into the circulation pump 500 becomes the ink that flows in from the communication port 191B. When this state further proceeds, the ink reversely flows from the second pressure control chamber 152 into the pressure chamber 12 through the collection flow path 140. In this state, the ink that flows out from the second pressure control chamber 152 into the circulation pump 500 and the ink that flows out into the pressure chamber 12 flow from the communication port 191B into the second pressure control chamber 152 through the bypass flow path 160. In this case, the pressure chamber 12 is filled with the ink in the supply flow path 130 and with the ink in the collection flow path 140, which are then ejected.

Note that the reverse flow of the ink observed when the recording duty is high is a phenomenon caused by the provision of the bypass flow path 160. While the example in which the communication port 191B in the second pressure adjustment unit 150 is brought into the open state as a result of the reverse flow of the ink has been described above, the ink may reversely flow in a state where the communication port 191B in the second pressure adjustment unit 150 is in the open state. Moreover, in a configuration in which the second pressure adjustment unit 150 is not provided also, the provision of the bypass flow path 160 may cause the reverse flow of the ink described above.

### Configuration of Ejection Unit

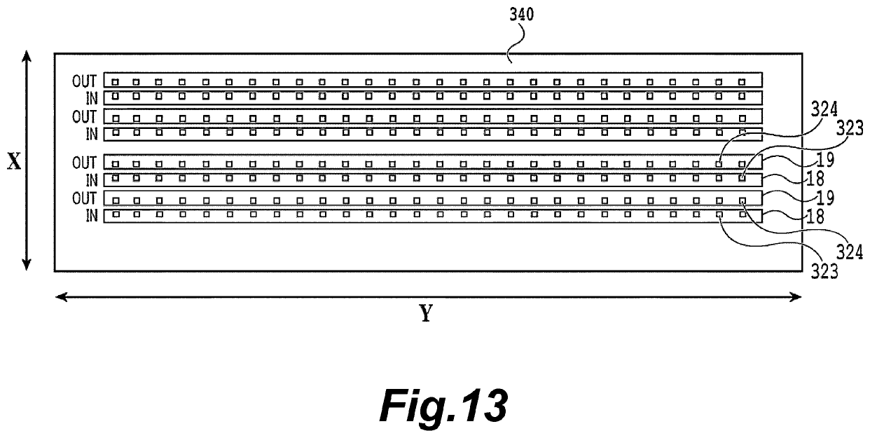

FIG. 11A and FIG. 11B are schematic diagrams illustrating the circulation route corresponding to one ink color in the ejection unit 3 in the present embodiment. FIG. 112A is an exploded perspective view obtained by viewing the ejection unit 3 from the first support member 4 side, while FIG. 11B is an exploded perspective view obtained by viewing the ejection unit 3 from the ejection module 300 side. Note that arrows denoted by IN and OUT in the drawings indicate ink flows, and a description will be given only of the ink flows corresponding to one color, but the flows are the same for another color. In addition, in FIG. 11A and FIG. 11B, illustration of the second support member 7 and the electric wiring member 5 is omitted, and a description thereof is also omitted in the following description of a configuration of the ejection unit 3. For the first support member 4 in FIG. 11A, a cross section thereof along a line XI-XI in FIG. 3A is illustrated. The ejection module 300 includes the ejection element substrate 340 and the aperture plate 330. FIG. 12 is a diagram illustrating the aperture plate 330, while FIG. 13 is a diagram illustrating the ejection element substrate 340.

To the ejection unit 3, the ink is supplied from the circulation unit 54 via the joint member 8 (see FIG. 3A and FIG. 3B). A description will be given of a route of the ink after passage of the ink through the joint member 8 till return of the ink to the joint member 8. Note that, in the following drawings, illustration of the joint member 8 is omitted.

The ejection module 300 includes the ejection element substrate 340 and the aperture plate 330, each of which is the silicon substrate 310, and further includes the ejection port forming member 320. The ejection element substrate 340, the aperture plate 330, and the ejection port forming member 320 are stacked and joined together so as to provide communication between the flow paths for the individual inks to result in the ejection module 300, which is supported by the first support member 4. The ejection module 300 is supported by the first support member 4 to form the ejection unit 3. The ejection element substrate 340 includes the ejection port forming member 320, the ejection port forming member 320 includes a plurality of ejection port trains including the ejection ports 13 arranged in rows, and a portion of the ink supplied via the ink flow paths in the ejection module 300 is ejected from the ejection ports 13. The ink that has not been ejected is collected via the ink flow paths in the ejection module 300.

As illustrated in FIG. 11A, FIG. 11B, and FIG. 12, the aperture plate 330 includes the plurality of arranged ink supply ports 311 and the plurality of arranged ink collection ports 312. As illustrated in FIG. 13 and FIG. 14A to FIG. 25C, the ejection element substrate 340 includes the plurality of arranged supply connection flow paths 323 and the plurality of arranged collection connection flow paths 324. The ejection element substrate 340 further includes the common supply flow paths 18 communicating with the plurality of supply connection flow paths 323 and the common collection flow paths 19 communicating with the plurality of collection connection flow paths 324. The ink flow paths in the ejection unit 3 are formed by providing communication between the ink supply flow paths 48 and the ink collection flow paths 49 (see FIG. 3A and FIG. 3B), which are provided in the first support member 4, and the flow paths provided in the ejection module 300. The support member supply ports 211 are cross-sectional openings forming the ink supply flow paths 48, while the support member collection ports 212 are cross-sectional openings forming the ink collection flow paths 49.

The ink to be supplied to the ejection unit 3 is supplied from the circulation unit 54 (see FIG. 3A) side to the ink supply flow paths 48 (see FIG. 3A) of the first support member 4. The ink that has flown through the support member supply ports 211 in the ink supply flow paths 48 is supplied to the common supply flow paths 18 of the ejection element substrate 340 via the ink supply flow paths 48 (see FIG. 3A) and the ink supply ports 311 of the aperture plate 330 to enter the supply connection flow paths 323. The flow paths described heretofore serve as supply-side flow paths. Then, the ink flows to the collection connection flow paths 324 serving as collection-side flow paths through the pressure chambers 12 (see FIG. 3B) of the ejection port forming member 320. Details of the ink flows in the pressure chambers 12 will be described later.

In the collection-side flow paths, the ink that has entered the collection connection flow paths 324 flows into the common collection flow paths 19. Then, the ink flows from the common collection flow paths 19 into the ink collection flow paths 49 of the first support member 4 via the ink collection ports 312 in the aperture plate 330 to be collected by the circulation unit 54 through the support member collection ports 212.

A region of the aperture plate 330 where the ink supply ports 311 and the ink collection ports 312 are not present corresponds to a region of the first support member 4 for separating the support member supply ports 211 and the support member collection ports 212 from each other. The region of the first support member 4 also has no opening. Such a region is used as an adhesive region when the ejection module 300 and the first support member 4 are bonded together.

In the aperture plate 330 in FIG. 12, the plurality of rows of openings arranged in the X-direction are provided in a plurality of rows in the Y-direction, and the supply (IN) openings and the collection (OUT) openings are alternately arranged in the Y-direction so as to displaced in the X-direction from each other by a half pitch. In FIG. 13, in the ejection element substrate 340, the common supply flow paths 18 communicating with the plurality of supply connection flow paths 323 arranged in the Y-direction and the common collection flow paths 19 communicating with the plurality of collection connection flow paths 324 arranged in the Y-direction are alternately arranged in the X-direction. The common supply flow paths 18 and the common collection flow paths 19 are divided on a per ink type basis, and the numbers of the common supply flow paths 18 and the common collection flow paths 19 to be arranged is determined according to the number of the ejection port trains for each color. The numbers of the supply connection flow paths 323 and the collection connection flow paths 324 to be arranged also correspond to the number of the ejection ports 13. Note that a one-to-one correspondence need not necessarily be provided, and it may also be possible that the one supply connection flow path 323 and the one collection connection flow path 324 correspond to the plurality of ejection ports 13.

The aperture plate 330 and the ejection element substrate 340 which have been described above are stacked and joined together so as to provide communication between the individual ink flow paths to result in the ejection module 300, which is supported by the first support member 4 to form the ink flow paths including supply flow paths and collection flow paths as described above.

FIG. 14A to FIG. 14C are cross-sectional views illustrating ink flows in different portions of the ejection unit 3. FIG. 14A illustrates a cross section along a line XIVa-XIVa in FIG. 11A, which is a cross section of a portion of the ejection unit 3 in which the ink supply flow paths 48 and the ink supply ports 311 communicate with each other. FIG. 14B illustrates a cross section along a line XIVb-XIVb in FIG. 11A, which is a cross section of a portion of the ejection unit 3 in which the ink collection flow paths 49 and the ink collection ports 312 communicate with each other. FIG. 14C illustrates a cross section along a line XIVc-XIVc in FIG. 11A, which is a cross section of a portion in which the ink supply ports 311 and the ink collection ports 312 do not communicate with the flow paths in the first support member 4.

In the supply flow paths that supply the ink, as illustrated in FIG. 14A, the ink is supplied from portions in which the ink supply flow paths 48 of the first support member 4 and the pink supply ports 311 of the aperture plate 330 overlap and communicate with each other. Meanwhile, in the collection flow paths that collect the ink, as illustrated in FIG. 14B, the ink is collected from portions in which the ink collection flow paths 49 of the first support member 4 and the ink collection ports 312 of the aperture plate 330 overlap and communicate with each other. As illustrated in FIG. 14C, in the ejection unit 3, the aperture plate 330 also locally has a region where no opening is provided. In such a region, the ink is neither supplied nor collected between the ejection element substrate 340 and the first support member 4. As illustrated in FIG. 14A, the ink is supplied in regions where the ink supply ports 311 are provided while, as illustrated in FIG. 14B, the ink is collected in regions where the ink collection ports 312 are provided. Note that, in the present embodiment, a configuration using the aperture plate 330 has been described as an example, but it may also be possible to use a mode in which the aperture plate 330 is not used. For example, it may also be possible to use a configuration in which flow paths corresponding to the ink supply flow paths 48 and the ink collection flow paths 49 are formed in the first support member 4, and the ejection element substrate 340 is bonded to the first support member 4.

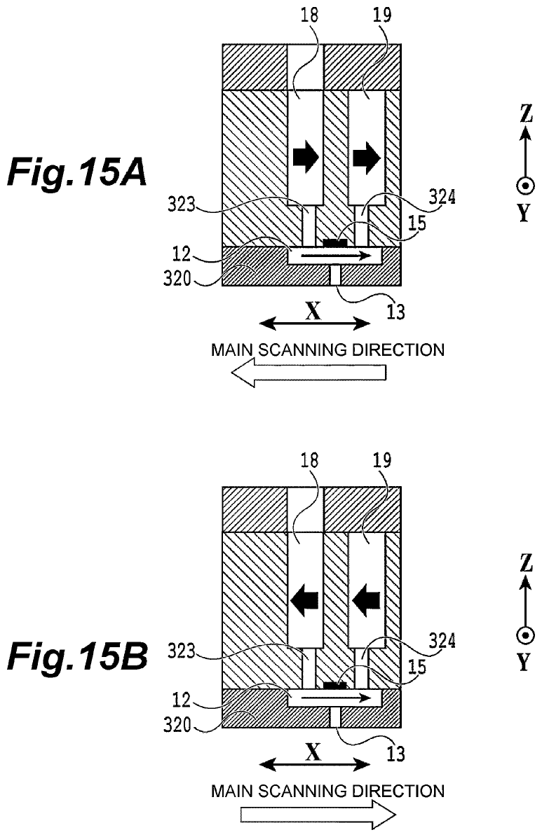

FIG. 15A and FIG. 15B are cross-sectional views illustrating the vicinity of the ejection ports 13 in the ejection module 300. FIG. 16A and FIG. 16B are cross-sectional views illustrating, as a comparative example, an ejection module having a configuration in which each of the common supply flow paths 18 and the common collection flow paths 19 is expanded in the X-direction. Note that each of thick arrows illustrated in the common supply flow path 18 and the common collection flow path 19 in FIG. 15A, FIG. 15B, FIG. 16A, and FIG. 16B indicates a swaying motion of the ink in a mode using the serial-type liquid ejection apparatus 50. The ink supplied to the pressure chamber 12 through the common supply flow path 18 and the supply connection flow path 323 is ejected from the ejection port 13 as a result of the driving of the ejection element 15. When the ejection element 15 is not driven, the ink is collected from the pressure chamber 12 into the common collection flow path 19 through the collection connection flow path 324 serving as the collection flow path.

In the mode using the serial-type liquid ejection apparatus 50, when the ink thus circulating is ejected, the ejection of the ink is rather affected by the swaying motion of the ink in the ink flow paths caused by the main scanning with the liquid ejection head 1. Specifically, an effect of the swaying motion of the ink in the ink flow paths may appear as different amounts of ink ejection or displacement between ejection directions. As illustrated in FIG. 16A and FIG. 16B, when the common supply flow path 18 and the common collection flow path 19 have cross-sectional shapes which are wide in the X-direction corresponding to the main scanning direction, the ink in each of the common supply flow path 18 and the common collection flow path 19 is susceptible to an inertial force in the main scanning direction to undergo a large swaying motion. As a result, the swaying motion of the ink may affect the ejection of the ink from the ejection port 13. In addition, when the common supply flow path 18 and the common collection flow path 19 are expanded in the X-direction, distances between the colors are enlarged to possibly reduce a printing efficiency.

Accordingly, in each of cross sections illustrated in FIG. 15A and FIG. 15B, each of the common supply flow path 18 and the common collection flow path 19 in the present embodiment is configured to extend in the Y-direction, and also extend in the Z-direction perpendicular to the X-direction corresponding to the main scanning direction. Such a configuration can reduce each of flow path widths of the common supply flow path 18 and the common collection flow path 19 in the main scanning direction. By reducing each of the flow path widths of the common supply flow path 18 and the common collection flow path 19 in the main scanning direction, the swaying motion of the ink caused by the inertial forces (thick black arrows in the drawings) which are exerted, during the main scanning, on the ink in the common supply flow path 18 and the common collection flow path 19 on a side opposite to the main scanning direction is reduced. Thus, the effect exerted by the swaying motion of the ink on the ejection of the ink can be reduced. In addition, by extending the common supply flow path 18 and the common collection flow path 19 in the Z-direction, cross-sectional areas are increased, and pressure losses in the flow paths are reduced.

As described above, the configuration is provided in which each of the flow path widths of the common supply flow path 18 and the common collection flow path 19 in the main scanning direction is reduced so as to reduce the swaying motion of the ink in each of the common supply flow path 18 and the common collection flow path 19 during the main scanning, but the swaying motion is not completely eliminated. Accordingly, in order to reduce an ejection difference on a per ink type basis, which is still caused by the reduced swaying motion, in the present embodiment, the common supply flow path 18 and the common collection flow path 19 are configured to be disposed at positions overlapping each other in the Y-direction.

As described above, in the present embodiment, the supply connection flow path 323 and the collection connection flow path 324 are provided to correspond to the ejection port 13 and have a correspondence relationship therebetween such that the supply connection flow path 323 and the collection connection flow path 324 are disposed to be arranged in the X-direction with the ejection port 13 being interposed therebetween. If there are portions in which the common supply flow path 18 and the common collection flow path 19 do not overlap in the Y-direction, the correspondence relationship between the supply connection flow path 323 and the collection connection flow path 324 in the X-direction is no longer established. In that case, the ink flows and ink ejection in the X-direction in the pressure chamber 12 may be affected thereby. In addition, the effect of the swaying motion of the ink may further affect the ejection of the ink from each of the ejection ports 13.

Accordingly, in the embodiment, the common supply flow path 18 and the common collection flow path 19 are disposed at positions overlapping each other in the Y-direction. Consequently, at any position in the Y-direction in which the ejection ports 13 are arranged, the ink swaying motion during the main scanning is substantially equal in each of the common supply flow path 18 and the common collection flow path 19. As a result, there is no significant fluctuation in the pressure difference between the common supply flow path 18 side and the common collection flow path 19 side which is produced in the pressure chamber 12, and therefore stable ejection can be performed.

In a liquid ejection head in which ink is circulated, a flow path that supplies the ink to the liquid ejection head and a flow path that collects the ink may be formed of the same flow path but, in the present embodiment, the common supply flow path 18 and the common collection flow path 19 are provided as separate flow paths. In addition, the supply connection flow path 323 and the pressure chamber 12 communicate with each other, the pressure chamber 12 and the collection connection flow path 324 communicate with each other, and the ink is ejected from the ejection port 13 of the pressure chamber 12. In other words, the pressure chamber 12 serving as a route connecting the supply connection flow path 323 and the collection connection flow path 324 is configured to include the ejection port 13. Accordingly, in the pressure chamber 12, ink flows of the ink flowing from the supply connection flow path 323 side to the collection connection flow path 324 side are generated, and the ink in the pressure chamber 12 is efficiently circulated. The efficient circulation of the ink in the pressure chamber 12 allows the ink in the pressure chamber 12 susceptible to an effect of ink evaporation from the ejection port 13 to be held in a fresh state.

If it becomes necessary to perform the ejection at a high flow rate due to the communication of the two flow paths, which are the common supply flow path 18 and the common collection flow path 19, with the pressure chamber 12, it is also possible to supply the ink from the both flow paths. In other words, the configuration in the present embodiment is advantageous over a configuration in which the supply and collection of the ink is implemented by only one flow path in that not only the circulation can efficiently be performed, but also the high-flow-rate ejection can also be performed.

The common supply flow path 18 and the common collection flow path 19, which are disposed at positions closer to each other in the X-direction, are less likely to be affected by the swaying motion of the ink. Preferably, the flow paths are configured to have an interval of 75 μm to 100 μm therebetween.

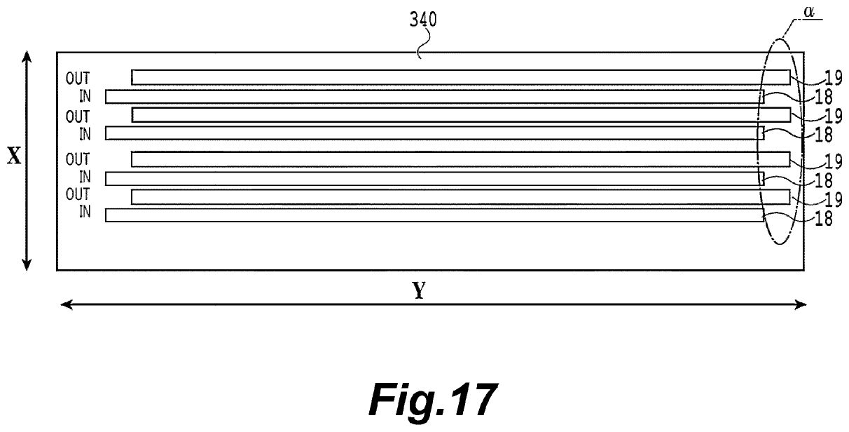

FIG. 17 is a diagram illustrating the ejection element substrate 340 as a comparative example. Note that, in FIG. 17, illustration of the supply connection flow paths 323 and the collection connection flow paths 324 is omitted. Into the common collection flow paths 19, the inks that have received thermal energy resulting from the ejection elements 15 in the pressure chambers 12 flow, and accordingly the inks at relatively high temperatures compared to temperatures of the inks in the common supply flow paths 18 flow. At this time, in the comparative example, the ejection element substrate 340 partly has a portion in the Y-direction in which only the common collection flow paths 19 are present, such as a portion a enclosed by a dot-dash line in FIG. 17. In other words, the common supply flow paths 18 and the common collection flow paths 19 do not overlap each other in at least one portion in the Y-direction. In this case, the temperature locally increases in that portion to result an uneven temperature in the ejection module 300, which may affect the ejection.

In the common supply flow paths 18, the inks at temperatures relatively lower than those in the common collection flow paths 19 flow. Accordingly, when the common supply flow paths 18 and the common collection flow paths 19 are adjacent to each other, the temperatures in the respective portions of the common supply flow paths 18 and the common collection flow paths 19 cancel out each other in the vicinities thereof, and consequently a temperature increase is suppressed. Therefore, the common supply flow paths 18 and the common collection flow paths 19 preferably have approximately equal lengths in the Y-direction, are located at positions overlapping each other in a substantially entire region in the Y-direction, and are adjacent to each other.

corresponding to the inks in three colors, which are cyan (C), magenta (M), and yellow (Y). In the liquid ejection head 1, as illustrated in FIG. 18A, the circulation flow paths are provided for the individual types of the inks. The pressure chambers 12 are provided along the X-direction serving as the main scanning direction of the liquid ejection head 1. In addition, as illustrated in FIG. 18B, the common supply flow path 18 and the common collection flow path 19 are provided along the ejection port train in which the ejection ports 13 are arranged so as to extend in the Y-direction such that the ejection port train is interposed between the common supply flow path 18 and the common collection flow path 19.

### Connection Between Main Body Portion and Liquid Ejection Head

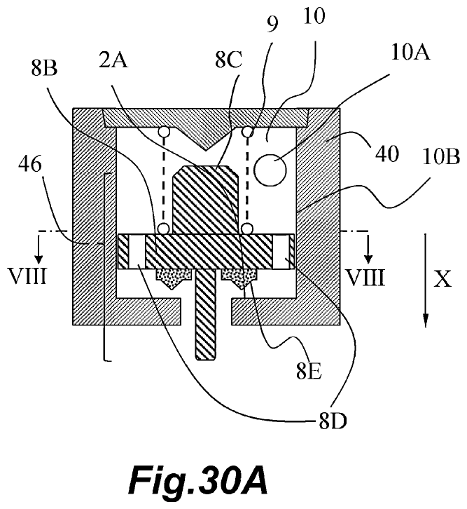

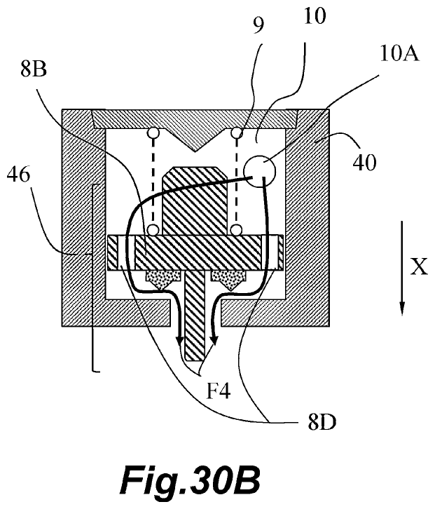

FIG. 30 is a schematic configuration diagram illustrating states of connection between the ink tank 2 and the external pump 21 which are provided in the main body portion of the liquid ejection apparatus 50 and the liquid ejection head 1 in the present embodiment and a location of the circulation pump 500 or the like in greater detail. The liquid ejection apparatus 50 in the present embodiment has a configuration which allows easy replacement of only the liquid ejection head 1 when a problem occurs in the liquid ejection head 1. Specifically, the liquid ejection apparatus 50 has a liquid connection portion 700 which allows easy connection and separation between the ink supply tube 59 connected to the external pump 21 and the liquid ejection head 1. This allows only the liquid ejection head 1 to be attached and detached to and from the liquid ejection apparatus 50.

As illustrated in FIG. 19, the liquid connection portion 700 has a liquid connector insertion port 53a provided in the head housing 53 of the liquid ejection head 1 to protrude therefrom and a cylindrical liquid connector 59a which can be inserted into the liquid connector insertion port 53a. The liquid connector insertion port 53a is fluidly connected to the ink supply flow path (inlet flow path) formed in the liquid ejection head 1 to be connected to the first pressure adjustment unit 120 via the filter 110 described previously. The liquid connector 59a is provided at a leading end of the ink supply tube 59 connected to the external pump 21 that supplies the ink in the ink tank 2 to the liquid ejection head 1 under a pressure.

As described above, the liquid ejection head 1 illustrated in FIG. 19 uses the liquid connection portion 700 to allow an operation of attaching/detaching and replacing the liquid ejection head 1 to be easily performed. However, when a sealing property between the liquid connector insertion port 53a and the liquid connector 59a deteriorates, the ink supplied by the external pump 21 under the pressure may leak out of the liquid connection portion 700. When the ink that has leaked out adheres to the circulation pump 500 or the like, a problem may occur in an electric system. To prevent this, in the present embodiment, the circulation pump and the like are placed as follows.

### Placement of Circulation Pump, Etc.

As illustrated in FIG. 19, in the present embodiment, to avoid adhesion of the ink that has leaked out of the liquid connection portion 700 to the circulation pump 500, the circulation pump 500 is placed above the liquid connection portion 700 in a gravity force direction. In other words, the circulation pump 500 is placed above the liquid connector insertion port 53a serving as a liquid inlet port of the liquid ejection head 1 in the gravity force direction. Additionally, the circulation pump 500 is placed at a position at which the circulation pump 500 is in non-contact with the members forming the liquid connection portion 700. As a result, even when the ink leaks out of the liquid connection portion 700, the ink flows in a horizontal direction corresponding to a direction in which the liquid connector 59a is open or downward in the gravity force direction, and accordingly it is possible to inhibit the ink from reaching the circulation pump 500 located thereabove in the gravity force direction. In addition, since the circulation pump 500 is placed at a position away from the liquid connection portion 700, a possibility that the ink follows the members to reach the circulation pump 500 is also reduced.

Moreover, an electrical connection portion 515 that electrically connects the circulation pump 500 and the electric contact substrate 6 via a flexible wiring member 514 is provided above the liquid connection portion 700 in the gravity force direction. This can reduce a possibility that electric trouble is caused by the ink from the liquid connection portion 700.

In addition, in the present embodiment, the wall portion 53b of the head housing 53 is provided and accordingly, even when the ink is emitted from an opening 59b of the liquid connection portion 700, it is possible to block the ink and reduce a possibility that the ink reaches the circulation pump 500 or the electrical connection portion 515.

### First Embodiment

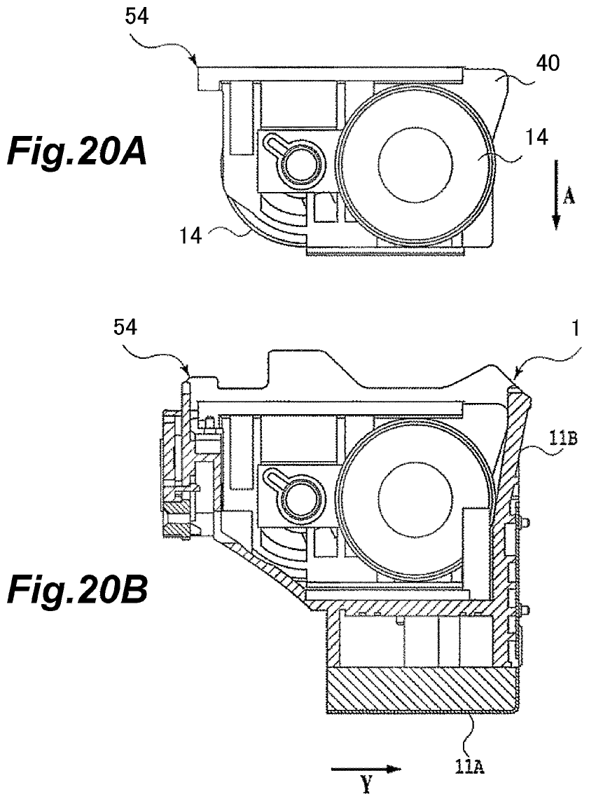

FIG. 20A and FIG. 20B are diagrams illustrating a direction in which the circulation unit 54 is to be attached to the liquid ejection head 1 in the first embodiment. In FIG. 20A, the circulation unit 54 is attached to the head housing 53 (see FIG. 2) of the liquid ejection head 1 in a direction indicated by an arrow A. Consequently, as illustrated in FIG. 20B, the circulation unit 54 is attached to the liquid ejection head 1. The liquid ejection head 1 has an ejection unit 11A capable of ejecting the ink and an attachment unit 11B to which the six circulation units 54 can be attached.

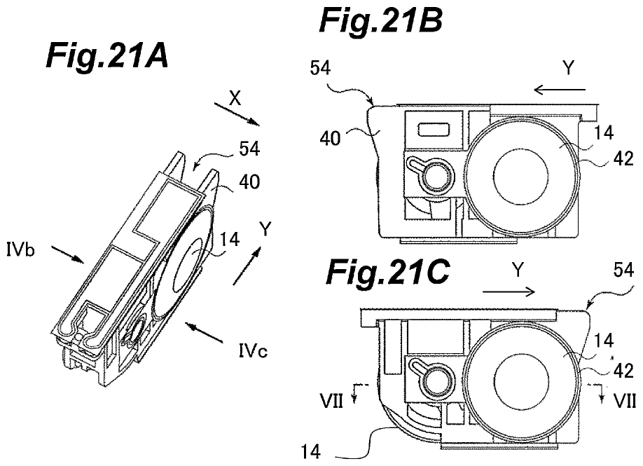

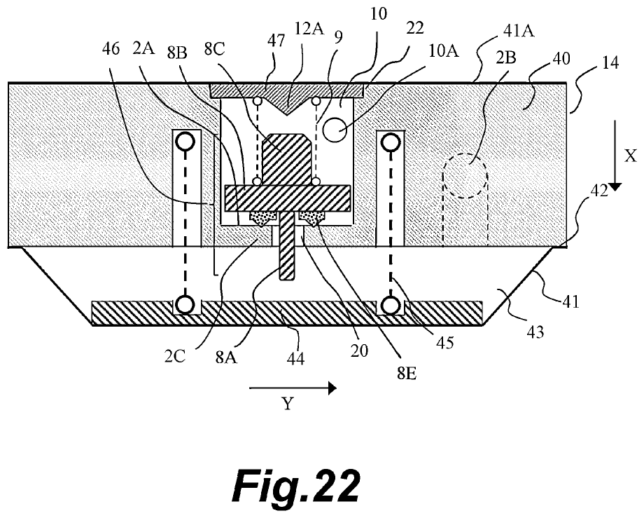

FIG. 21A is a perspective view of the circulation unit 54 in FIG. 20A and FIG. 20B, FIG. 21B is a view along an arrow IVb in FIG. 21A, and FIG. 21C is a view along an arrow IVc in FIG. 21A. FIG. 22 is a diagram illustrating a portion of a valve unit 14 in a cross section of the circulation unit 54 along a line VII-VII in FIG. 21C. A case 40 of the one circulation unit 54 includes the two valve units 14. The two valve units 14 have the same configuration, and accordingly only one of the valve units 14 is illustrated in FIG. 22. The two valve units 14 are disposed to be arranged in a direction (first direction) crossing the direction A of attachment of the circulation unit 54. In the present embodiment, the two valve units 14 are formed to be arranged in a sub-scanning direction indicated by an arrow Y and perpendicular to the attachment direction A.

Each of the valve units 14 includes a pressure chamber 43, a valve containing chamber 10, a valve spring 9, a spring 45, a pressure plate 44, a flexible film 41, and a valve body containing plate 47. The valve containing chamber 10 is a first chamber to which a liquid is supplied from an external tank, and the pressure chamber 43 is a second chamber communicating with an ejection unit that ejects the liquid. The pressure chamber 43 of one of the valve units 14 is open in a side surface of the case 40 on one side (+X-direction side) in the X-direction, while the pressure chamber 43 of another of the valve units 14 is open in a side surface of the case 40 on another side (−X-direction side) in the X-direction. Around an opening portion of each of the pressure chamber 43, a film fixation surface 42 to which the flexible film 41 is to be attached is formed, and the opening portion is closed with the flexible film 41.

The flexible film 41 is formed in a protruded shape projecting in an outward direction (+X direction when the pressure chamber 43 is open on the +X direction side) so as to ensure a large cubic volume for the pressure chamber 43, which is a truncated cone shape. However, the shape of the flexible film 41 is an example, and is not limited to the truncated cone shape. One end portion of the flexible film 41 in the X-direction is fixed to the pressure plate 44, while another end portion thereof in the X-direction is fixed to the film fixation surface 42 corresponding to a part of the case 40. The flexible film 41 is a flexible member forming a part of a wall surface of the pressure chamber 43 and supporting the pressure plate 44. The pressure plate 44 is fixed to the flexible film 41 by heat sealing. The pressure plate 44 is a movable wall forming a part of a planar surface of the pressure chamber 43 and configured to be movable according to the pressure of the ink in the pressure chamber 43. Note that a method of fixing the flexible film 41 to the pressure plate 44 is not limited to the heat sealing.

The spring 45 is configured such that one end portion thereof in the X-direction is fixed to the case 40 and another end portion thereof is fixed to the pressure plate 44 so as to exert an outward force on the pressure plate 44. Accordingly, the spring 45 is a second force exerting member that exerts on the pressure plate 44 a force in a direction of increasing the cubic volume of the pressure chamber 43.

In the case 40, the valve containing chamber 10 is formed at a position facing the pressure chamber 43 in an arrow X direction. The case 40 has a portion forming a partition wall 2C separating the pressure chamber 43 and the valve containing chamber 10 from each other. In the partition wall 2C, a through hole 20 is formed to provide communication between the pressure chamber 43 and the valve containing chamber 10. In the valve containing chamber 10, a valve 46 is provided to open/close the through hole 20. A wall surface of the partition wall 2C which faces the inside of the valve containing chamber 10 forms a valve seat 2A of the valve 46. Between a body portion 8B of the valve 46 and the valve body containing plate 47 forming a wall surface of the valve containing chamber 10 which faces the partition wall 2C, the valve spring 9 is provided. The valve spring 9 exerts a force to press the valve 46 in the direction (+X-direction) toward the valve seat 2A. The valve body containing plate 47 is press-fitted into an opening portion 22 provided in a wall surface of the case 40 which faces the partition wall 2C so as to close the opening portion 22.

The valve 46 includes a penetrating portion 8A, the body portion 8B, and a protruded portion 8C. The penetrating portion 8A is configured to extend from the body portion 8B toward the pressure chamber 43, penetrate through the through hole 20 of the partition wall 2C, and enter the inside of the pressure chamber 43. The penetrating portion 8A has an outer diameter smaller than an inner diameter of the through hole 20. The body portion 8B is contained in the valve containing chamber 10. The body portion 8B has an outer diameter smaller than an inner diameter of the valve containing chamber 10. The protruded portion 8C projects from the body portion 8B toward the valve body containing plate 47 and has an outer diameter smaller than an inner diameter of the valve spring 9 to be located inside the valve spring 9 and guide expansion and contraction thereof. The valve spring 9 has an outer diameter smaller than the outer diameter of the body portion 8B and one end portion thereof (+X-direction-side end portion) in contact with the body portion 8B, while having another end portion thereof (−X-direction-side end portion) in contact with the valve body containing plate 47, to be compressed in the X-direction between the body portion 8B and the valve body containing plate 47.

The valve 46 is assembled into the valve containing chamber 10 in a state where the opening portion 22 is open before the opening portion 22 is closed with the valve body containing plate 47 in the following procedures (1) to (3):
(1) The penetrating portion 8A of the valve 46 is inserted into the through hole 20 to place a seal portion 8E of the valve 46 on the valve seat 2A;
(2) The valve spring 9 is placed from above the body portion 8B of the valve 46 so as to surround the protruded portion 8C; and
(3) The valve body containing plate 47 is press-fitted into the opening portion 22, while the valve spring 9 is compressed with the valve body containing plate 47.

In the present embodiment, at a center portion of a surface of the valve body containing plate 47 which faces the valve 46, a protruded portion 12A is provided. Thus, in the assembly procedure (2) described above, a center axis of the valve spring 9 is guided so as not be significantly deviated from a center axis of the valve body containing plate 47. After the valve body containing plate 47 is press-fitted into the opening portion 22, a flexible film 41A is welded to the entire surface so as to cover a surface (upper surface in FIG. 22) of the valve body containing plate 47 opposite to a surface thereof facing the valve containing chamber 10 as well as a surface (upper surface in FIG. 22) of the case 40 provided with the opening portion 22. Thus, a strength of fixation and airtightness between the opening portion 22 and the valve body containing plate 47 are ensured.

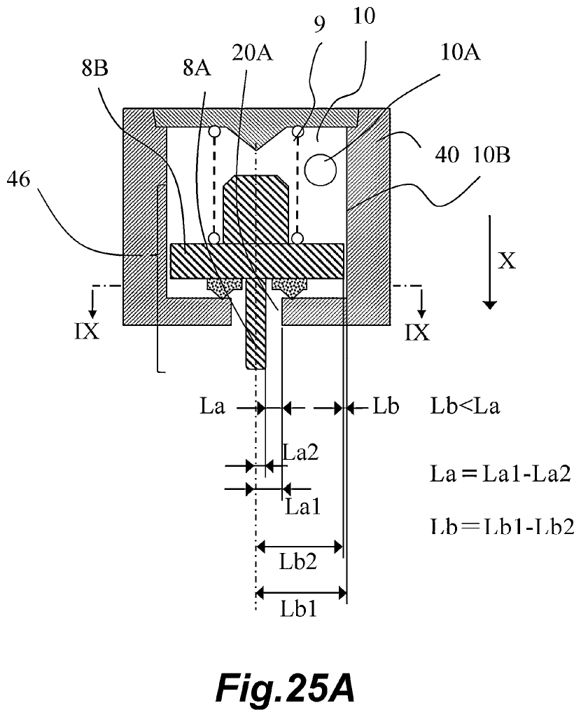

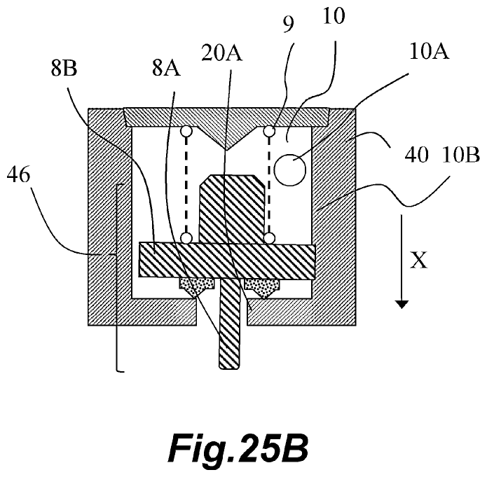

The valve containing chamber 10 forms a part of a supply path for supplying the ink from the external ink tank 2, and the ink supplied from the ink tank 2 flows into the valve containing chamber 10 from an ink inlet port 10A provided in the valve containing chamber 10. In a state in FIGS. 25A and 25B, the seal portion 8E of the valve 46 is pressed against the valve seat 2A by the valve spring 9 to come into contact with the valve seat 2A. Thus, a space between the through hole 20 in the partition wall 2C separating the pressure chamber 43 and the valve containing chamber 10 from each other and the valve containing chamber 10 is sealed, and the pressure chamber 43 and the valve containing chamber 10 no longer communicate with each other. Additionally, the flexible film 41 is largely expanded outward (in the +X-direction). The penetrating portion 8A is apart from the pressure plate 44, while the protruded portion 8C of the valve 46 is apart from the valve body containing plate 47.

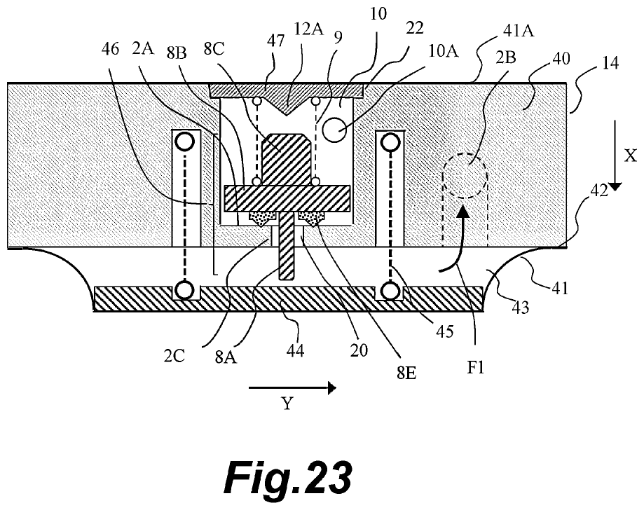

As illustrated in FIG. 23, as a result of ink consumption by the liquid ejection head 1, the ink in the pressure chamber 43 decreases and a negative pressure in the pressure chamber 43 increases to deform the flexible film 41 and bring the pressure plate 44 closer to the penetrating portion 8A. As indicated by an arrow F1, the ink in the pressure chamber 43 flows out of the pressure chamber 43 through an ink outlet port 2B to be supplied to the ejection module 300 of the liquid ejection head 1 serving as an ejection unit that ejects a liquid onto a recording medium. When the ink in the pressure chamber 43 decreases, the flexible film 41 is deformed to move the pressure plate 44 in a direction (−X-direction) of approaching the valve containing chamber 10. The ink that has not been ejected in the ejection module 300 is circulated by the circulation pump 500 in the pressure chamber 43 of the valve unit 14. The circulation pump 500 and the valve unit 14 form the circulation unit 54 which is a circulation device.

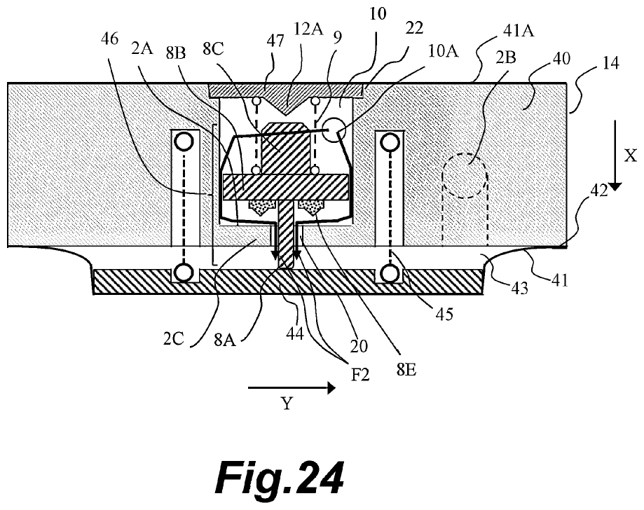

As illustrated in FIG. 24, when the negative pressure in the pressure chamber 43 increases to be at least a predetermined level, the pressure plate 44 comes into contact with the penetrating portion 8A of the valve 46. When the pressure plate 44 further moves in the direction (−X-direction) of approaching the valve containing chamber 10, the pressure plate 44 pushes the valve 46 in the −X-direction against the force in the valve closing direction (+X-direction) which is exerted by the valve spring 9 on the valve 46 to release the penetrating portion 8A. As a result, the seal portion 8E of the valve 46 is separated from the valve seat 2A. Then, the ink supplied from the ink inlet port 10A flows into the pressure chamber 43 through a gap between the valve containing chamber 10 and the body portion 8B of the valve 46 and through a gap between the through hole 20 and the penetrating portion 8A of the valve 46, as indicated by an arrow F2. Thus, the valve 46 is configured to be movable in an axis line direction (X-direction) between a valve open position where the ink can flow through the through hole 20 and a valve close position where the ink flow in the through hole 20 is cut off. The valve open position is an open position where a flow of the liquid through the through hole can be allowed and the valve close position is a restricted position where a flow of the liquid through the through hole can be restricted. The valve spring 9 is a force exerting member that exerts, on the valve 46, a force in a direction toward the valve close position. The valve unit 14 is configured such that the pressure plate 44 moving with the decrease of the ink pressure in the pressure chamber 43 comes into contact with the penetrating portion 8A to move the penetrating portion 8A in the −X-direction against the force of the valve spring 9 and thereby move the valve 46 to the valve open position.

FIG. 25A and FIG. 25B are diagrams each illustrating portions of the valve containing chamber 10, the valve 46, and the case 40 of the valve unit 14. As illustrated in FIG. 25A, at the time of assembling the valve 46 into the valve containing chamber 10, when La is a width of a gap between an outer peripheral surface of the penetrating portion 8A and an inner wall surface 20A of the through hole 20 and Lb is a width of a gap between the outer peripheral surface of the body portion 8B and an inner wall surface 10B of the valve containing chamber 10, La>Lb is satisfied.

It is to be noted herein that La is a difference between a distance La1 from a center of the through hole 20 to the inner wall surface 20A and a distance La2 from a center of the penetrating portion 8A to the outer peripheral surface of the penetrating portion 8A, and La=La1−La2 is satisfied. Meanwhile, Lb is a difference between a distance Lb1 from a center of the valve containing chamber 10 to the inner wall surface 10B and a distance Lb2 from a center of the body portion 8B to the outer peripheral surface of the body portion 8B, and Lb=Lb1-Lb2 is satisfied. In another definition, La is ½ of a difference between the inner diameter of the through hole 20 and the outer diameter of the penetrating portion 8A, while Lb is ½ of a difference between the inner diameter of the valve containing chamber 10 and the outer diameter of the body portion 8B.

When a relationship given by La>Lb is satisfied, it is possible to inhibit the valve 46 from being significantly deviated from the center or inclined in the valve containing chamber 10. In addition, even when the body portion 8B is inclined, the inclination is minimized as illustrated in FIG. 25B while, even when the penetrating portion 8A comes into contact with the inner wall surface 10B of the valve containing chamber 10, it is possible to inhibit the penetrating portion 8A from coming into contact with the inner wall surface 20A of the through hole 20. Consequently, an orientation of the valve 46 in the valve containing chamber 10 is stabilized, and an orientation of the valve spring 9 is stabilized to enable the valve spring 9 to stably operate. Moreover, since the penetrating portion 8A is inhibited from coming into contact with the inner wall surface 20A of the through hole 20, a flow path for the ink is reliably ensured when the valve is opened. A ratio between La and Lb is required to satisfy La≥1.2×Lb. Meanwhile, a relationship between La and Lb need not be satisfied in an entire region in a peripheral direction and, as long as the relationship between La and Lb is locally satisfied, the foregoing effect can be obtained.

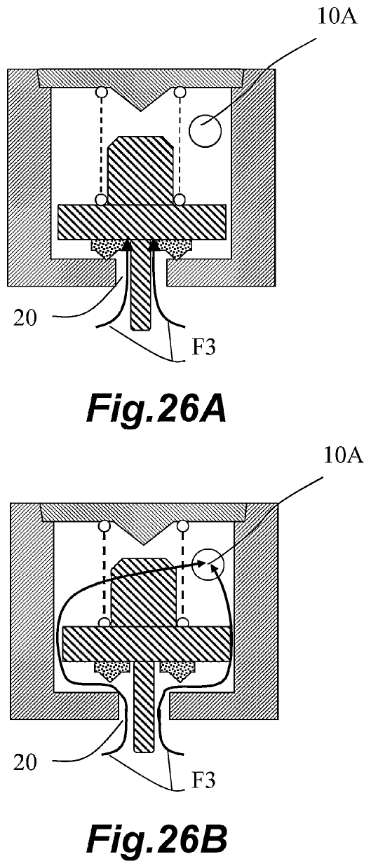

Note that, as illustrated in FIG. 26A and FIG. 26B, even when the ink flow is reverse to that in FIG. 24, i.e., when the ink flows in from the through hole 20 and flows out into the ink inlet port 10A, the valve unit 14 in the first embodiment functions. In addition, even when the ink thus reversely flows, the relationship between La and Lb satisfying the foregoing relationship allows the same effect as obtained when the ink forwardly flows to be obtained.

### Comparative Example

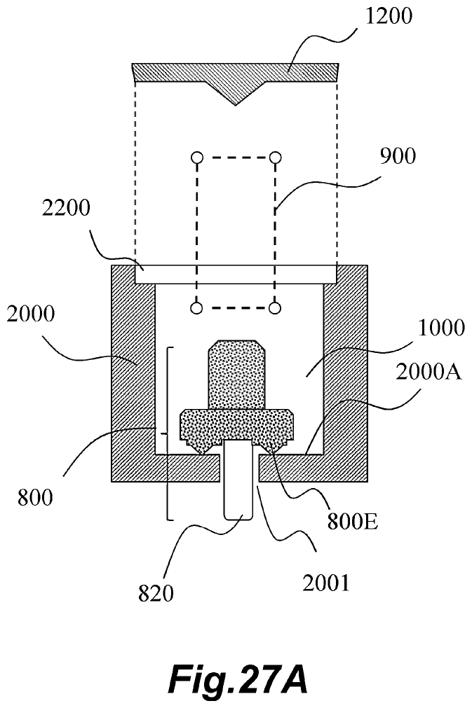

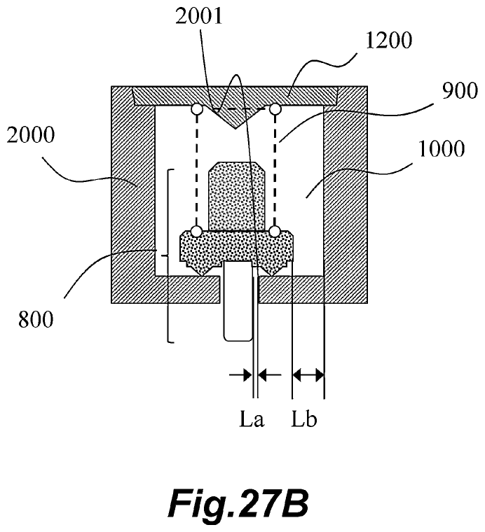

A description will be given herein of a comparative example to be compared to the valve unit 14 in the first embodiment. FIG. 27A and FIG. 27B are diagrams illustrating portions of a valve containing chamber 1000, a valve 800, and a case 2000 of a valve unit in the comparative example. In the case 2000 of the valve unit, the valve containing chamber 1000 in which the valve 800 is to be contained is provided. Assembly of the valve unit is performed by inserting the valve 800 into the valve containing chamber 1000, and then press-fitting a valve body containing plate 1200 into an opening portion 2200, while compressing a valve spring 900 from above with the valve body containing plate 1200. The assembly of the valve unit is performed in a state where a seal portion 800E of the valve 800 is in close contact with a valve seat 2000A on a bottom surface of the valve containing chamber 1000.

An outer diameter of a penetrating portion 820 of the valve 800 is smaller than an inner diameter of a through hole 2001. Meanwhile, an outer diameter of a body portion 800B of the valve 800 is smaller than an inner diameter of the valve containing chamber 1000. When La is a gap between an outer peripheral surface of the penetrating portion 820 and an inner peripheral surface of the through hole 2001 and Lb is a gap between the body portion 800B and an inner wall surface of the valve containing chamber 1000, La<Lb is satisfied. In other words, when La is ½ of a difference between the outer diameter of the penetrating portion 820 and the inner diameter of the through hole 2001 and Lb is ½ of a difference between the outer diameter of the body portion 800B and the inner diameter of the valve containing chamber 1000, La<Lb is satisfied.

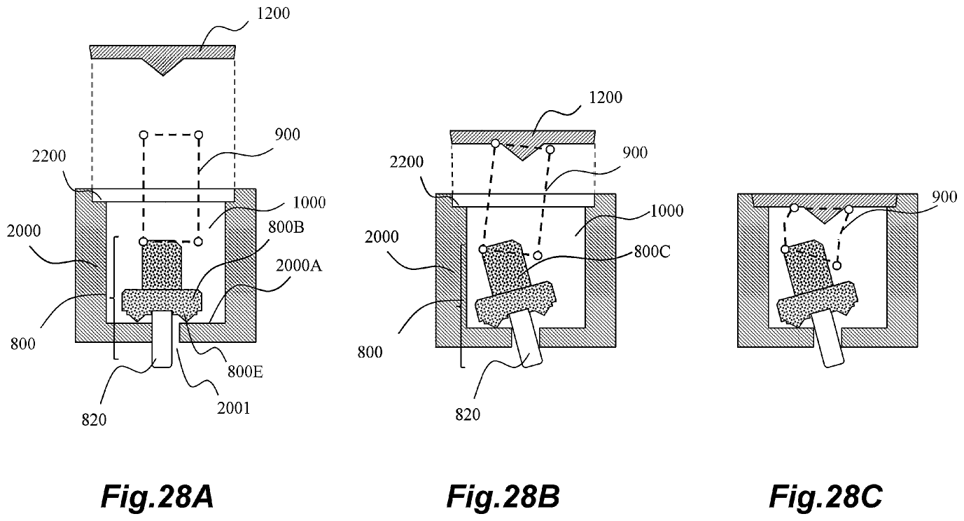

In this case, as illustrated in FIG. 28A, it may be possible that the valve 800 is deviated from a center of the valve containing chamber 1000, and the penetrating portion 820 is inserted, while being in contact with the through hole 2001. In this state, when the penetrating portion 820 is pushed with the valve body containing plate 1200 while the valve spring 900 is compressed from above, the valve spring 900 may get caught by a protruded portion 800C of the valve 800 to significantly incline the valve 800, as illustrated in FIG. 28B.

In this state, when the valve body containing plate 1200 is further pushed to be press-fitted into the opening portion 2200, the valve spring 900 is bent as illustrated in FIG. 28C, and the valve 800 stays in a collapsed orientation inside the valve containing chamber 1000, resulting in an assembly failure. In a state where the valve spring 900 is bent, an operation of opening/closing the valve 800 is not appropriately performed, the penetrating portion 820 blocks an ink flow in the through hole 2001 as illustrated in FIG. 28B and FIG. 28C, and the valve cannot perform the function thereof.

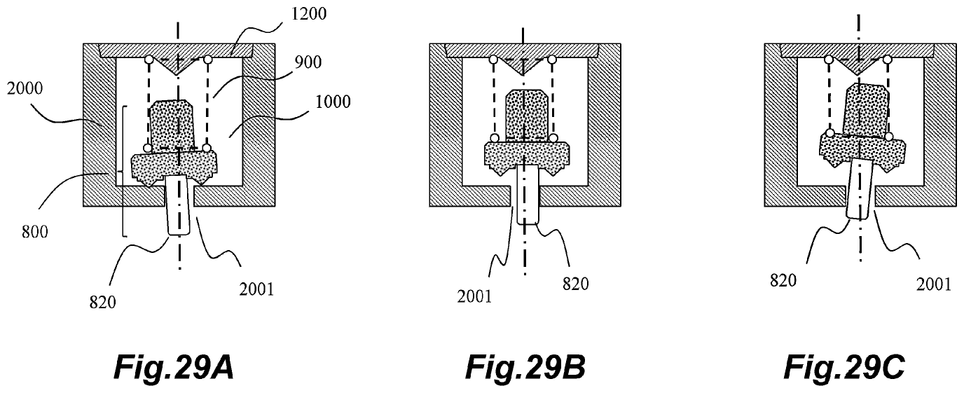

Even when the valve unit is assembled without bending of the valve spring 900, during the operation of the valve 800, the penetrating portion 820 may shift leftward or rightward to possibly come into contact with a side surface of the through hole 2001, as illustrated in FIG. 29A, FIG. 29B, and FIG. 29C. In this case, a shape of an ink flow path defined by a gap between the penetrating portion 820 and the through hole 2001 becomes irregular to possibly disturb an ink flow passing therethrough and cause foaming due to a turbulent flow.

### Second Embodiment

Referring to FIGS. 30A and 30B, a description will be given of the second embodiment. As illustrated in FIG. 30A, in the valve 46 in the second embodiment, an ink flow path 8D is provided in the body portion 8B to extend therethrough in the X-direction. A position where the ink flow path 8D is provided is external of a position where the seal portion 8E comes into contact with the valve seat 2A in a radial direction. As illustrated in FIG. 30B, in a state where the valve 46 is at the valve open position, the ink flow path 8D serves as an ink flow path aside from a gap between the body portion 8B and the inner wall surface of the valve containing chamber 10. This ensures a flow path F4 providing communication between an upper portion and a lower portion of the body portion 8B. Consequently, the gap between the body portion 8B and the inner wall surface 10B of the valve containing chamber 10, i.e., the gap Lb between the outer peripheral surface of the body portion 8B and the inner wall surface 10B thereof can further be set narrower. By setting Lb narrower, it is possible to more reliably inhibit the valve 46 from being significantly deviated from the center or inclined in the valve containing chamber 10 and stabilize the operation of opening/closing the valve 46.

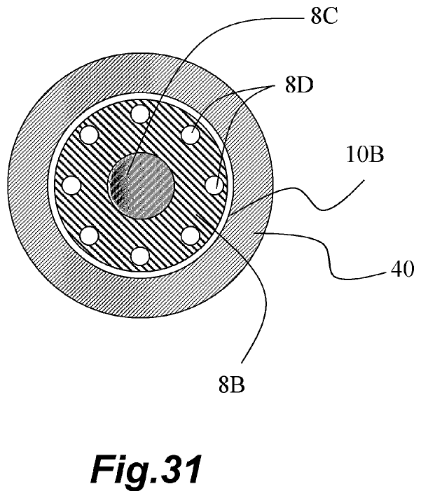

FIG. 31 is a cross-sectional view taken along a line VIII-VIII in FIG. 30A. In the example illustrated in FIG. 31, the body portion 8B has a circular cross-sectional shape, and the eight ink flow paths 8D are provided at positions close to the outer peripheral surface to be spaced apart from each other in the peripheral direction such that the ink flow paths 8D extend through the body portion 8B in the X-direction along a center axis line of the valve 46. Each of the ink flow paths 8D also has a circular cross-sectional shape. Note that the ink flow paths 8D in the body portion 8B are not limited to the shapes, positions, and number in FIG. 30A, FIG. 30B, and FIG. 31 as long as each of the ink flow paths 8D is a flow path that permits the ink flow in the X-direction at a place other than the gap between the outer peripheral surface of the body portion 8B and the inner wall surface of the valve containing chamber 10, which has the width Lb. In a case where the ink flow paths 8D are formed of through holes, the cross-sectional shapes thereof are not limited to circular shapes, the positions thereof are not limited to locations which are equidistant in the peripheral direction, and the number thereof is not limited to 8.

### Third Embodiment

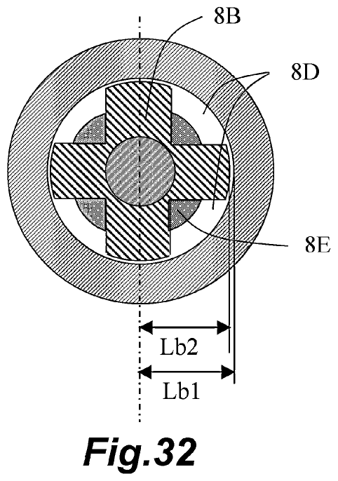

Referring to FIG. 32, a description will be given of the third embodiment. In the second embodiment, the ink flow paths 8D are the through holes provided in the body portion 8B but, in the third embodiment, the ink flow paths 8D are formed by providing the body portion 8B with notched shapes. In the example in FIG. 32, the body portion 8B has a shape obtained by cutting away pillar shapes each having a sectoral cross section from a cylindrical shape. Each of the notched shapes has a sectoral cross section and extends in the X-direction along the center axis line of the valve 46. In a state where the valve 46 is at the valve open position, these notched portions function as the ink flow paths 8D aside from the gap between the body portion 8B and the inner wall surface of the valve containing chamber 10. From the body portion 8B having such a shape also, as long as Lb<La is satisfied at a plurality of locations, the same effect as obtained in the first embodiment can be obtained. In the example in FIG. 32, the plurality of locations where Lb<La is satisfied are portions of a cylindrical surface. The plurality locations may appropriately be such that, in a cross section perpendicular to the X-direction, the center axis line of the body portion 8B is included in a polygonal shape obtained by connecting center points of arcs corresponding to the cylindrical surface where Lb<La is satisfied in the peripheral direction.

### Fourth Embodiment

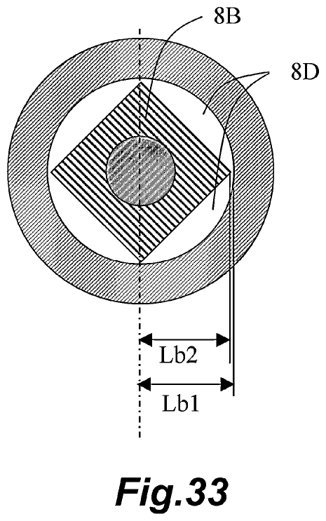

Referring to FIG. 33, a description will be given of the fourth embodiment. In the fourth embodiment, in the same manner as in the third embodiment, the ink flow paths 8D are formed by providing the body portion 8B with notched shapes. In the example in FIG. 33, the body portion 8B has a shape obtained by cutting away pillar shapes each having an arched cross section from a cylindrical shape, and the notched portions each having the arched cross section and extending in the X-direction function as the ink flow paths 8D. In the example in FIG. 33, the shape is obtained by cutting away the four pillar shapes each having the arched cross section, and a center angle of an arc forming each of the arched shape is 90 degrees, and accordingly the plurality of locations where Lb<La is satisfied correspond to a generating line of a cylindrical surface. In this case also, when the plurality of locations are such that, in a cross section perpendicular to the X-direction, the center axis line of the body portion 8B is included in a polygonal shape obtained by connecting center points of arcs corresponding to the cylindrical surface where Lb<La is satisfied in the peripheral direction, the same effect as obtained in the first embodiment can be obtained.

### Fifth Embodiment

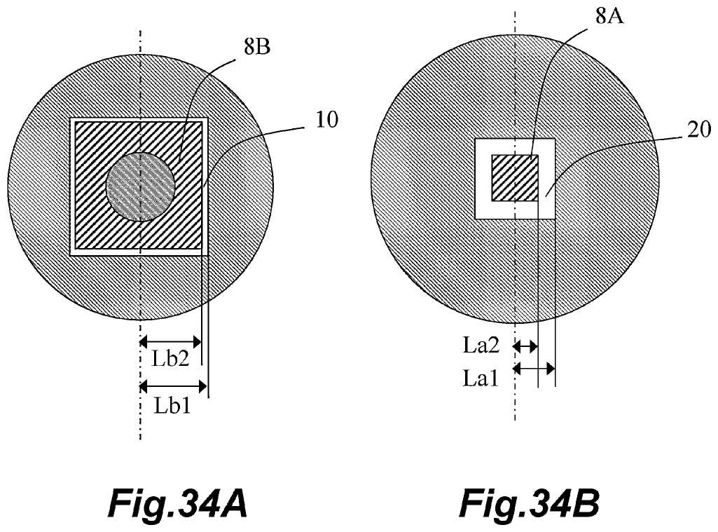

Referring to FIG. 34A and FIG. 34B, a description will be given of the fifth embodiment. In the fifth embodiment, as illustrated in FIG. 34A, the valve containing chamber 10 has a rectangular cross-sectional shape, and the body portion 8B of the valve 46 also has a rectangular shape. In addition, as illustrated in FIG. 34B, the through hole 20 has a rectangular cross-sectional shape, and the penetrating portion 8A of the valve 46 also has a rectangular cross-sectional shape. Note that FIG. 34B is a cross-sectional view along a line IX-IX in FIG. 25A. Thus, the cross-sectional shapes of the body portion 8B of the valve 46, the valve containing chamber 10, the penetrating portion 8A, and the through hole 20 which are perpendicular to the direction (X-direction) in which the valve 46 moves are not limited to circular shapes as those in the first embodiment. No matter what the cross-sectional shapes may be, as long as the gap La between the outer peripheral surface of the penetrating portion 8A and the inner wall surface of the through hole 20 and the gap Lb between the outer peripheral surface of the body portion 8B and the inner wall surface of the valve containing chamber 10 satisfy Lb<La, the same effect as obtained in the first embodiment can be obtained. Note that the cross-sectional shapes of the valve containing chamber 10 and the body portion 8B and the cross-sectional shapes of the through hole 20 and the penetrating portion 8A may be in any combination.

### Sixth Embodiment

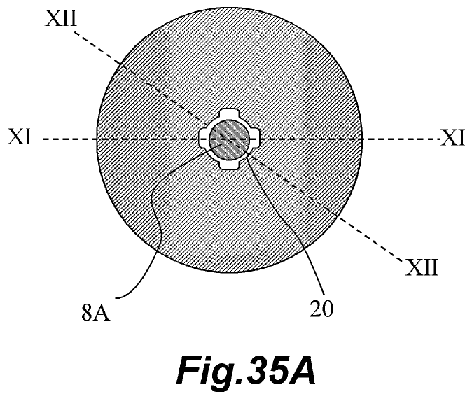

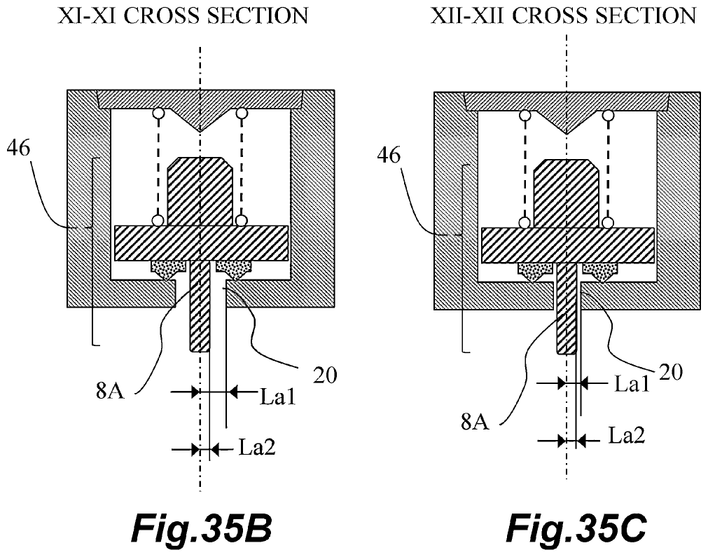

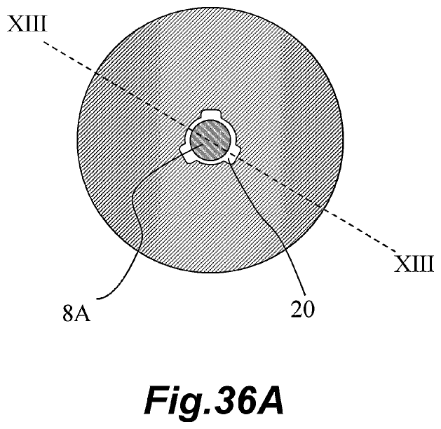

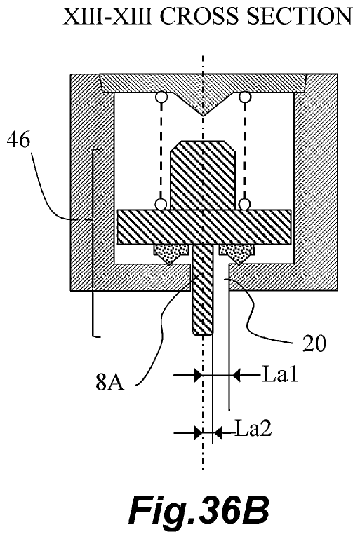

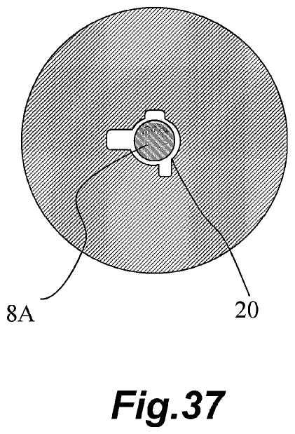

Referring to FIG. 35A to FIG. 35C, a description will be given of the sixth embodiment. In the sixth embodiment, as illustrated in FIG. 35A, the through hole 20 has a cross-sectional shape which is partially widened in the radial direction. Note that FIG. 35A is a cross-sectional view along a line IX-IX in FIG. 25A. When the cross-sectional shape of the through hole 20 is as such, depending on positions in the peripheral direction, there are portions where the distance La1 between the center axis line of the penetrating portion 8A and the inner wall surface of the through hole 20 is larger as illustrated in FIG. 35B and portions where the distance La1 is smaller as illustrated in FIG. 35C. Note that FIG. 35B is a cross-sectional view along a line XI-XI in FIG. 35A, while FIG. 35C is a cross-sectional view along a line XII-XII in FIG. 35A. In the portions where La1 is larger, it is possible to ensure the ink flow paths while, in the portions where La1 is smaller, the penetrating portion 8A is less likely to collapse, and it is possible to inhibit the entire valve 46 from collapsing. Note that, in the partially radially widened shape of the opening of the through hole 20, a width of a gap between the penetrating portion 8A and the through hole 20 need not necessarily be bilaterally symmetrical in a cross section through the center axis line of the valve 46 as in FIG. 36A, FIG. 36B, and FIG. 37. FIG. 36A and FIG. 37 are cross-sectional views along the line IX-IX in FIG. 25A, while FIG. 36B is a cross-sectional view along a line XIII-XIII in FIG. 36A. In the example in FIG. 35A to FIG. 35C, in each of cross sections (FIG. 35B and FIG. 35C) through the center axis line of the valve 46, the width of the gap between the through hole 20 and the penetrating portion 8A is bilaterally symmetrical. Meanwhile, in the example in FIG. 36A and FIG. 36B, in a cross section (FIG. 36B) through the center axis line of the valve 46, the width of the gap between the through hole 20 and the penetrating portion 8A is not bilaterally symmetrical. In this case also, when there are a plurality of portions where Lb<La is satisfied, the same effect as achieved in the first embodiment is achieved.

According to the present disclosure, it is possible to enable a stable valve operation in a valve unit in which a valve capable of opening/closing a through hole provided in a partition wall separating a valve containing chamber and a pressure chamber from each other in a state where a portion of a valve body is inserted in the through hole is provided in the valve containing chamber.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-081542, filed on May 17, 2023, which is hereby incorporated by reference herein in its entirety.

What is claimed is:

1. A valve unit comprising:
a first chamber to which a liquid is supplied from an external tank;
a second chamber communicating with an ejection unit that ejects the liquid;
a partition wall separating the first chamber and the second chamber from each other and provided with a through hole making the first chamber and the second chamber communicate with each other; and
a valve including (i) a body portion to be contained in the first chamber and (ii) a penetrating portion having an outer diameter smaller than an inner diameter of the through hole and provided in the body portion so as to penetrate through the through hole and extend to the inside of the second chamber,
wherein the valve is movable between an open position where a flow of the liquid through the through hole can be allowed and a restricted position where a flow of the liquid through the through hole can be restricted,
wherein, when La is a width of a gap between an outer peripheral surface of the penetrating portion and an inner wall surface of the through hole and Lb is a width of a gap between an outer peripheral surface of the body portion and an inner wall surface of the first chamber, La≥1.2×Lb is satisfied.

2. The valve unit according to claim 1,
wherein, in a state where the valve is at the open position, the body portion has a flow path of the liquid, aside from the gap between the outer peripheral surface of the body portion and the inner wall surface of the first chamber.

3. The valve unit according to claim 2,
wherein the flow path has a shape penetrating through the body portion along a center axis line of the valve.

4. The valve unit according to claim 2,
wherein the flow path has a notched shape extending along a center axis line of the valve.

5. The valve unit according to claim 1,
wherein each of cross-sectional shapes of the body portion and the first chamber, which are perpendicular to a direction in which the valve moves, is a circular shape.

6. The valve unit according to claim 1,
wherein each of cross-sectional shapes of the body portion and the first chamber, which are perpendicular to a direction in which the valve moves, is a rectangular shape.

7. The valve unit according to claim 1,
wherein each of cross-sectional shapes of the penetrating portion and the through hole, which are perpendicular to a direction in which the valve moves, is a circular shape.

8. The valve unit according to claim 1,
wherein each of cross-sectional shapes of the penetrating portion and the through hole, which are perpendicular to a direction in which the valve moves, is a rectangular shape.

9. The valve unit according to claim 1,
wherein a cross-sectional shape of the through hole, which is perpendicular to a direction in which the valve moves, is a shape partially widened in a radial direction.

10. The valve unit according to claim 1, further comprising:
a force exerting member that exerts, on the valve, a force in a direction toward the restricted position; and
a movable wall forming a part of a wall surface of the second chamber and configured to be movable according to the pressure of the liquid in the second chamber,
wherein the movable wall that moves with a decrease of a pressure of the liquid in the second chamber comes into contact with the penetrating portion to move the penetrating portion against the force of the force exerting member, and thereby move the valve to the open position.

11. The valve unit according to claim 10, further comprising:
a flexible member forming a part of the wall surface of the second chamber and supporting the movable wall.

12. The valve unit according to claim 10,
wherein the force exerting member is a spring provided between the body portion and a wall surface of the first chamber which faces the partition wall.

13. The valve unit according to claim 10, further comprising:
a second force exerting member that exerts, on the movable wall, a force in a direction of increasing a cubic volume of the second chamber.

14. The valve unit according to claim 1,
wherein a wall surface of the partition wall which faces the first chamber is used as a valve seat, and
wherein the valve has a seal portion that comes into contact with the valve seat to seal a space between the first chamber and the through hole.

15. A liquid ejection head comprising:
a valve unit including:
a first chamber to which a liquid is supplied from an external tank;
a second chamber communicating with an ejection unit that ejects the liquid;
a partition wall separating the first chamber and the second chamber from each other and provided with a through hole making the first chamber and the second chamber communicate with each other; and
a valve including (i) a body portion to be contained in the first chamber and (ii) a penetrating portion having an outer diameter smaller than an inner diameter of the through hole and provided in the body portion so as to penetrate through the through hole and extend to the inside of the second chamber,
wherein the valve is movable between an open position where a flow of the liquid through the through hole can be allowed and a restricted position where a flow of the liquid through the through hole can be restricted,
wherein, when La is a width of a gap between an outer peripheral surface of the penetrating portion and an inner wall surface of the through hole and Lb is a width of a gap between an outer peripheral surface of the body portion and an inner wall surface of the first chamber, La≥1.2×Lb is satisfied; and
an ejection unit that ejects the liquid supplied from the second chamber of the valve unit.

16. The liquid ejection head according to claim 15, further comprising:
a circulation device that circulates, in the valve unit, the liquid that has not been ejected from the ejection unit.

17. A recording apparatus comprising:
a valve unit including:
a first chamber to which a liquid is supplied from an external tank;
a second chamber communicating with an ejection unit that ejects the liquid;
a partition wall separating the first chamber and the second chamber from each other and provided with a through hole making the first chamber and the second chamber communicate with each other; and
a valve including (i) a body portion to be contained in the first chamber and (ii) a penetrating portion having an outer diameter smaller than an inner diameter of the through hole and provided in the body portion so as to penetrate through the through hole and extend to the inside of the second chamber,
wherein the valve is movable between an open position where a flow of the liquid through the through hole can be allowed and a restricted position where a flow of the liquid through the through hole can be restricted,
wherein, when La is a width of a gap between an outer peripheral surface of the penetrating portion and an inner wall surface of the through hole and Lb is a width of a gap between an outer peripheral surface of the body portion and an inner wall surface of the first chamber, La≥1.2×Lb is satisfied;
a tank that supplies the liquid to the first chamber of the valve unit; and
an ejection unit that ejects, onto a recording medium, the liquid supplied from the second chamber of the valve unit.

18. The recording apparatus according to claim 17, further comprising:
a circulation device that circulates, in the valve unit, the liquid that has not been ejected from the ejection unit.
